(19) United States
(12) Patent Application Publication
(10) Pub. No.: US 2026/0052217 A1
(43) Pub. Date: Feb. 19, 2026

(54) STORAGE MEDIUM STORING PROGRAM THAT MAKES IT POSSIBLE TO CORRECT SKEW OF SCANNED IMAGE, AND CONTROL METHOD

(71) Applicant: CANON KABUSHIKI KAISHA, Tokyo (JP)

(72) Inventor: TSUBASA OCHIAI, Chiba (JP)

(21) Appl. No.: 19/290,684

(22) Filed: Aug. 5, 2025

(30) Foreign Application Priority Data
Aug. 14, 2024 (JP) 2024-135307

(51) Int. Cl. H04N 1/387; H04N 1/00

(52) U.S. Cl. CPC H04N 1/3878; H04N 1/00421; H04N 1/0044; H04N 1/0097; H04N 2201/0094

(57) ABSTRACT

A non-transitory computer-readable storage medium storing a program supporting a general-purpose program which can be commonly used for image processing apparatuses of a plurality of makers, each having a scan function. The program causes a computer to extract a feature amount from an image acquired by the scan function, display a setting reception screen for receiving a setting of skew correction processing for correcting, in a case where the scanned image is skewed, skew of this scanned image, and instruct the image processing apparatus to execute the skew correction processing according to the setting received on the setting reception screen.

### BACKGROUND

### Field of the Technology

The present disclosure relates to a storage medium storing a program that makes it possible to correct skew of a scanned image, and a control method.

### Description of the Related Art

To a scanning device (scanner) that performs image reading, i.e. scanning, a host computer (information processing apparatus) is communicably connected which is capable of processing information between the same and the scanning device. As control software for controlling the scanning device, for example, a scan driver is used which is installed from the scanning device into the host computer. With this scan driver, it is possible to provide a scan instruction from the host computer to the scanning device. In the host computer, an operating system (hereinafter referred to as the “OS”) as basic software is installed in advance. The scan driver is configured according to specifications defined by the OS and can operate when called from the OS. Further, the scan driver is different for each vendor that supplies a scanning device, i.e. a model specific driver which is suitable on a scanning device basis.

In recent years, in Windows (registered trademark), a standard class driver (hereinafter sometimes referred to as the “standard driver”) is provided which can be commonly used even for scanning devices supplied from a plurality of different vendors, respectively. The standard driver is incorporated in the OS in advance. Then, by connecting a desired scanning device to a host computer having the OS in which the standard driver is incorporated, the standard driver can be used. This makes it possible to omit installation of the model-specific scan driver described above. Further, the standard driver is assumed to be configured to enable designation of a scan function of the scanning device according to scan function information generated based on information acquired from the scanning device. This makes it possible to designate a scan function on a scanning device basis by one standard driver.

The standard driver can be commonly used for the scanning devices of a plurality of different vendors, and hence, for example, there is a case where it is impossible to cause a scanning device of a predetermined vendor to execute part of functions of this scanning device. Japanese Laid-Open Patent Publication No. 2021-033526 discloses a program that extends a print function of a print service which can be used for general purpose regardless of a model or vendor of the image forming apparatus. With this, by operating a print setting screen adapted to an individual image forming apparatus on a model basis and on a vendor basis, it is possible to cause the image forming apparatus to execute a print function which cannot be executed if only by the print service which can be used for general purpose.

The scanning device sometimes reads an original in a skewed state, due to mechanical positional shift of the original caused when the original is conveyed. Further, in a case where an original placed on the scanning device is skewed as well, the scanning device reads the original in this skewed state. In both cases, the scanned image becomes a skewed image. However, in a case where a scanned image is a skewed image, even when a user desires to correct the skew of the scanned image, i.e. change the scanned image into a state without skew, it is impossible for the general-purpose driver to correct the scanned image to the state without skew.

### SUMMARY

The present disclosure is directed to providing a mechanism that is capable of correcting, in a case where a scanned image is skewed, the skew of this scanned image.

In a first aspect of the present disclosure, there is provided a non-transitory computer-readable storage medium storing a program supporting a general-purpose program which can be used for image processing apparatuses of a plurality of makers, each having a scan function, the program causing a computer to perform extraction of a feature amount from an image obtained by the scan function, and display a setting reception screen for receiving a setting of skew correction processing for correcting, in a case where the image has a skew, the skew of the image based on the feature amount.

In a second aspect of the present disclosure, there is provided a non-transitory computer-readable storage medium storing a program supporting a general-purpose program which can be used for image processing apparatuses of a plurality of makers, each having a scan function, the program causing a computer to perform extraction of a feature amount from an image obtained by the scan function, perform display of a setting reception screen for receiving a setting of skew correction processing for correcting, in a case where the image has a skew, the skew of the image based on the feature amount, and perform execution of the skew correction processing according to the setting received on the setting reception screen.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram showing a hardware configuration of a scan system according to a first embodiment.

FIGS. 2A-A and 2A-B are block diagrams each showing a software configuration of the scan system.

FIG. 2B is a schematic view showing a configuration of a scanning device.

FIGS. 2C-A and 2C-B are diagrams each showing an example of a scanned image acquired by the scanning device.

FIG. 2D is a flowchart of a skew correction process performed by the scanning device.

FIGS. 3A-A to 3A-C are diagrams each showing an example of a screen displayed on a display section of the scan system.

FIGS. 3B-A and 3B-B are diagrams each showing an example (variation) of the screen displayed on the display section of the scan system.

FIG. 4 is a flowchart of a process performed by a scan function-extending unit, for editing scan function information.

FIGS. 5A to 5C are diagrams each showing an example of a list of the scan information.

FIG. 6 is a sequence diagram showing a process executed between a scan application, general-purpose scan software, an extension application, and a scanning device, after the scan application receives a scan setting instruction.

FIG. 7 is a flowchart of a process performed by the extension application.

FIG. 8 is a flowchart of a process performed by the scanning device.

FIG. 9 is a sequence diagram showing a process executed, in a second embodiment, between the scan application, the general-purpose scan software, the extension application, and the scanning device, after the scan application receives a scan setting instruction.

FIG. 10 is a sequence diagram showing a process executed, in a third embodiment, between the scan application, the general-purpose scan software, the extension application, and the scanning device, after the scan application receives a scan setting instruction.

FIG. 11 is a flowchart of a process performed by the extension application.

FIG. 12 is a flowchart of a process performed by the scan function-extending unit in a fourth embodiment, for editing the scan function information.

FIG. 13 is a diagram showing an example of a list of capabilities information of the scanning device.

FIG. 14 is a sequence diagram showing a process executed between the scan application, the general-purpose scan software, the extension application, and the scanning device, after the scan application receives a scan setting instruction.

FIGS. 15A and 15B are diagrams each showing an example of a list of the scan information in a fifth embodiment.

FIG. 16 is a diagram showing an example of a screen displayed on the display section of the scan system.

FIG. 17 is a sequence diagram showing a process executed between the scan application, the general-purpose scan software, the extension application, and the scanning device, after the scan application receives a scan setting instruction.

FIG. 18 is a sequence diagram showing a process executed, in a sixth embodiment, between the scan application, the general-purpose scan software, the extension application, and the scanning device, after the scan application receives a scan setting instruction.

FIGS. 19A and 19B are diagrams each showing an example of a screen displayed on the display section of the scan system.

### DESCRIPTION OF THE EMBODIMENTS

The present disclosure will now be described in detail below with reference to the accompanying drawings showing embodiments thereof. The configuration described in the following embodiments is given only by way of example, and is by no means intended to limit the scope of the present disclosure. For example, components of the configuration of the present disclosure can be replaced with desired components which can exhibit the same function. Further, desired components can be added. Further, two or more desired components (features) of the embodiments can be combined.

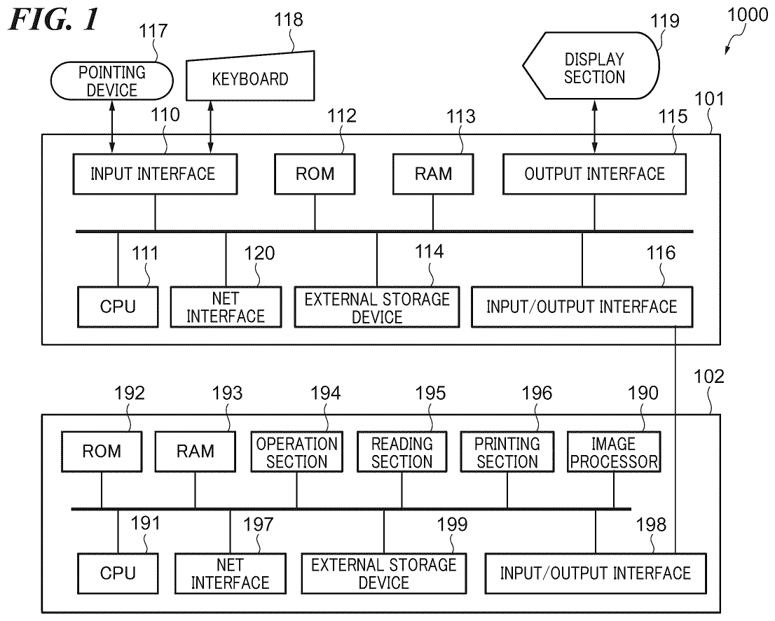

A first embodiment will be described below with reference to FIGS. 1 to 8.

FIG. 1 is a block diagram showing a hardware configuration of a scan system according to the first embodiment. As shown in FIG. 1, the scan system, denoted by reference numeral 1000, includes a host computer 101, a scanning device (scanner) 102, a pointing device 117, a keyboard 118, and a display section 119, and these are communicably connected to each other. The host computer 101 is an information processing apparatus and includes an input interface 110, a central processing unit (CPU) 111, a read only memory (ROM) 112, a random access memory (RAM) 113, an external storage device (storage medium) 114, an output interface 115, an input/output interface 116, and a network (NET) interface 120. Note that although as the host computer 101, for example, a desktop-type personal computer can be used, this is not limitative, but for example, a laptop-type personal computer, a tablet terminal, and a smartphone can be used.

The CPU 111 is a computer that executes e.g. programs stored in the ROM 112 and the external storage device 114. Note that in the present embodiment, the CPU 111 is capable of executing functions and processing of the host computer 101 by performing processing according to a program code stored in the ROM 112. In the ROM 112, an initialization program is stored. In the external storage device 114, an application program group, an operating system (OS), print data generation software, and a variety of other data are stored. Note that in the present embodiment, as the OS, Windows (registered trademark) 11 of Microsoft (registered trademark) has been installed in the host computer 101. The external storage device 114 is not particularly limited, but for example, a hard disk drive (HDD) or a solid state drive (SSD) can be used. The RAM 113 is used e.g. as a work memory when a variety of programs stored in the external storage device 114 are executed, and the variety of programs can operate in the host computer 101. To the input interface 110, the pointing device 117 and the keyboard 118 as input devices are connected. To the output interface 115, the display section 119 as a display device is connected. On the display section 119, for example, a scan setting screen 300A and a detailed setting screen 300C, described hereinafter, are displayed. The NET interface 120 is a network interface and performs control to transfer data to and from an external apparatus via a network. To the input/output interface 116, the scanning device 102 is connected. This enables the host computer 101 to communicate with the scanning devices 102 of a plurality of makers, i.e. process information between the host computer 101 and the scanning devices 102 of the plurality of makers regardless of the maker of the scanning device 102. The host computer 101 and the scanning device 102 can be wired connected or can be wirelessly connected.

The scanning device 102 includes an image processor 190, a CPU 191, a ROM 192, a RAM 193, an operation section 194, a reading section 195, a printing section 196, a NET interface 197, an input/output interface 198, and an external storage device 199. The CPU 191 is a computer that executes e.g. programs stored in the ROM 192 and the external storage device 199 and performs centralized control of the scanning device 102. The ROM 192 is a memory for storing the programs. The RAM 193 is a memory for temporarily storing a program and image data. On the operation section 194, a variety of operation instructions can be provided to the scanning device 102. The reading section 195 reads an image from an original. The printing section 196 prints an image on a sheet based on image data generated by reading an image from an original in the reading section 195. Note that the printing section 196 can be omitted. The NET interface 197 is a network interface and performs control to transfer data to and from an external apparatus via a network. To the input/output interface 198, the host computer 101 is connected. To the image processor 190, for example, image data generated by reading an image from an original in the reading section 195 is input. Then, the image processor 190 performs various types of edit processing operations on the image data.

The scanning device 102 is not particularly limited insofar as it is an apparatus having an image reading function, i.e. a scan function, and, for example, an image processing apparatus, such as a multi-function peripheral (MFP), can be used. Further, in a case where the MFP is used as the scanning device 102, printing performed by the MFP is printing using the electrophotographic method in the present embodiment but this is not limitative and, for example, printing using the inkjet method can be performed. Further, although in the present embodiment, the host computer 101 and the scanning device 102 are separately configured, this is not limitative. For example, the host computer 101 and the scanning device 102 can be configured as an integrated apparatus.

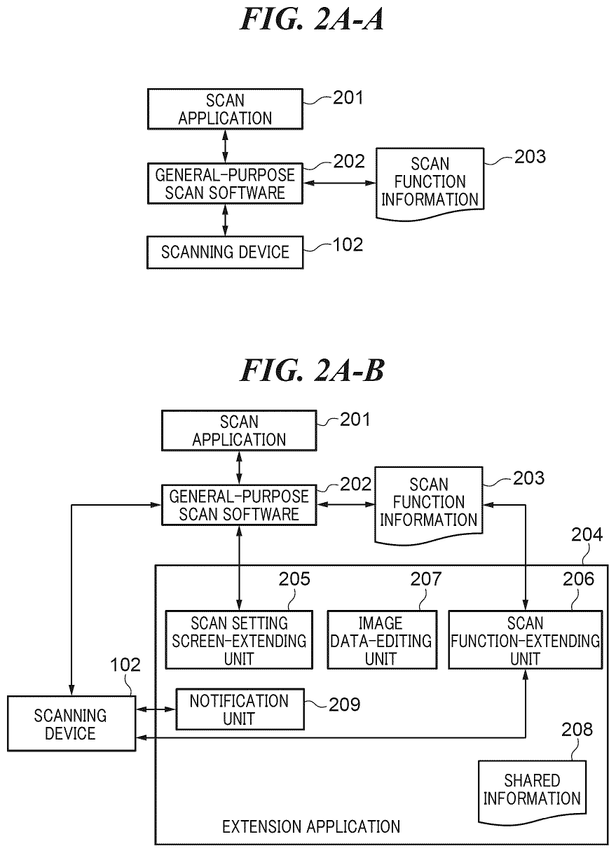

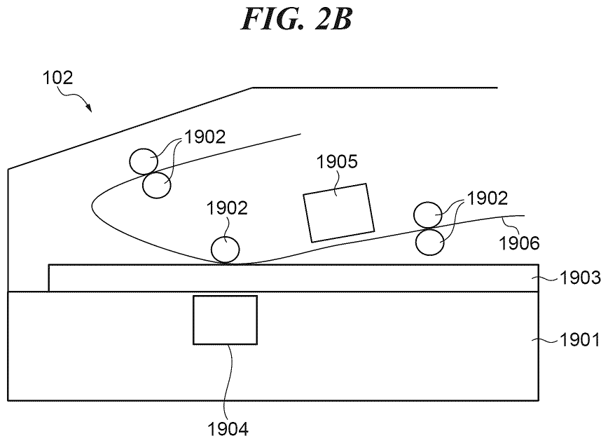

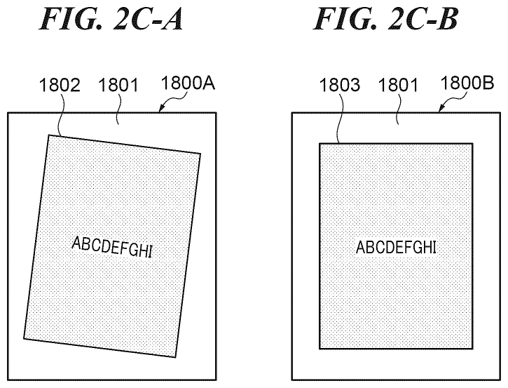

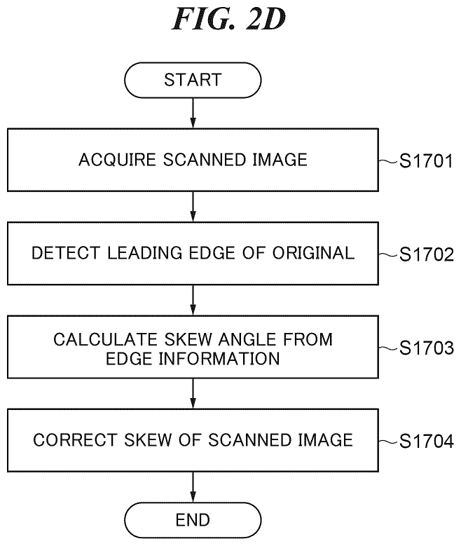

FIGS. 2A-A and 2A-B are block diagrams each showing a software configuration of the scan system. FIG. 2A-A is a diagram showing a general configuration in a case where an extension application (program) 204 is not associated with general-purpose scan software (general-purpose program) 202 and the scanning device 102. FIG. 2A-B is a diagram showing a configuration in a case where the extension application 204 is associated with the general-purpose scan software 202 and the scanning device 102. The general-purpose scan software 202 is a general-purpose program (standard driver) which can be commonly used for the scanning devices 102 of a plurality of makers, for example, when scanning (image reading) is performed. That is, the general-purpose scan software 202 is a class driver which can be commonly used for the scanning devices 102 supplied from the plurality of makers. This general-purpose scan software 202 is provided with the OS as one of functions included in the OS package. The general-purpose scan software 202 can perform processing for a wide range of the scanning devices 102 by using a standardized scanning method. With this, the general-purpose scan software 202 can generate and output an instruction which can be interpreted by the scanning devices 102 of the plurality of makers. The general-purpose scan software 202 is installed in the OS in advance. The extension application 204 is a program which supports, i.e. assists the general-purpose scan software 202 (program for executing a control method for performing control to support the general-purpose scan software 202). In the present embodiment, the extension application 204 is an extension program which can extend functions which cannot be executed by the general-purpose scan software 202 for the scanning device 102, but this is not limitative. For example, the extension application 204 can be a program which improves the convenience of functions which can be executed by the general-purpose scan software 202 for the scanning device 102. The extension application 204 is stored e.g. in the external storage device 114 together with the OS (the general-purpose scan software 202). With this, the host computer 101 has the general-purpose scan software 202 and the extension application 204.

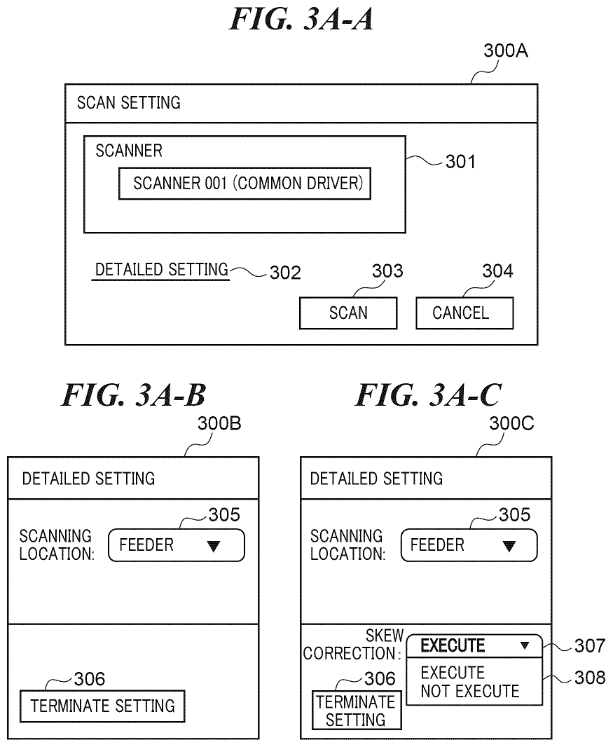

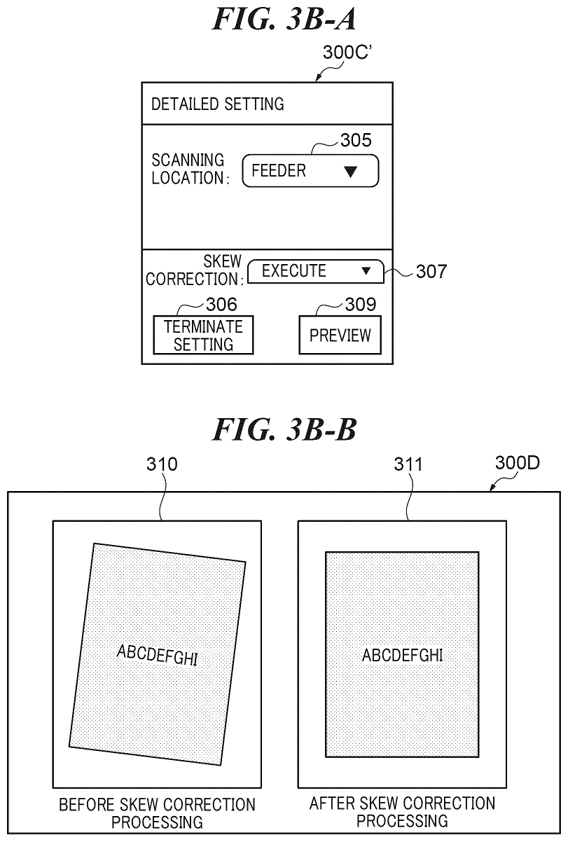

First, referring to FIG. 2A-A, the configuration in the case where the extension application 204 is not associated with the general-purpose scan software 202 and the scanning device 102 will be described. A scan application 201 is software for taking in contents (image data) generated by scanning performed by the scanning device 102. The scan application 201 is not particularly limited, but, for example, a document generation application and an image editing application are used. The scan application 201 issues a scan instruction to the OS e.g. upon receipt of a scan request from a user. The scan instruction includes scan setting information for instructing operations of the general-purpose scan software 202 and the scanning device 102. To issue a scan instruction, the scan application 201 can display the scan setting screen 300A on the display section 119, provided by one of the general-purpose scan software 202, the OS, and the scan application 201. Further, when a control 302 in the scan setting screen 300A is operated (pressed), the scan application 201 can display a detailed setting screen 300B (see FIG. 3A-B) on the display section 119. The scan setting screen 300A, the detailed setting screen 300B, and further, the detailed setting screen 300C will be described hereinafter. The scan setting screen 300A includes a setting item indicating a scan function which can be set according to capabilities information acquired by the general-purpose scan software 202, i.e. information which can be set as the scan setting, and a control item indicating its setting. The capabilities information refers to information related to the capabilities of the scanning device 102 for performing scan. Further, with this capabilities information, it is also possible to determine whether or not information which enables the display of the detailed setting screen 300C is included (determination step). Then, as a result of this determination, if it is determined that the information which enables the display of the detailed setting screen 300C is included, the detailed setting screen 300C can be displayed. On the other hand, if it is determined that the information which enables the display of the detailed setting screen 300C is not included, the display of the detailed setting screen 300C is inhibited. Thus, the extension application 204 can switch whether or not to display the detailed setting screen 300C according to the capabilities information of the scanning device 102.

Scan function information 203 is scan function-indicative data describing all scan functions which can be set, settings of these scan functions, an exclusive relation between settings, and so forth. The scan function information 203 is included in a configuration file of the general-purpose scan software 202 and is stored in the external storage device 114 as an unchangeable file. Alternatively, the scan function information 203 is dynamically generated by the general-purpose scan software 202. Specifically, the general-purpose scan software 202 acquires attribute data of the scanning device 102 from the scanning device 102. The general-purpose scan software 202 generates the scan function information 203 according to attribute information in the attribute data. Note that in a case where the scan function information 203 is dynamically generated, as described above, the scan information 203 can be edited. Further, the attribute data of the scanning device 102 includes the attribute information indicating the functions which can be designated in the scanning device 102 (capabilities of the scanning device 102) and settings associated with the attribute information, and these are stored in the RAM 113.

With this configuration, the general-purpose scan software 202 enables a user to designate a scan function which can be used in the scanning device 102 according to the scanning device 102 connected to the host computer 101. With this, regardless of the scanning device 102, i.e. even in a case where the scanning device 102 having a different function or the scanning device 102 developed by a different scanner maker is connected, it is possible to designate a scan function which can be used in the connected scanning device 102. Note that in the present embodiment, the general-purpose scan software 202 is a standard class driver that executes scanning based on a standard scan protocol called Mopria (registered trademark). Specifically, the general-purpose scan software 202 is not a scan driver specific to a model of the scanning device 102 but is a standard class driver which can be commonly used for scanning devices 102 of scanner makers, without depending on a specific scanner maker. Further, the general-purpose scan software 202 acquires the capabilities information of the scanning device 102 and generates the scan function information 203 based on the acquired information. Further, the general-purpose scan software 202 can be associated with the extension application 204. This enables the general-purpose scan software 202 to execute a function which is not supported by the general-purpose scan software 202. For example, the general-purpose scan software 202 cannot receive a setting of skew correction processing for correcting, in a case where an image read by the scanning device 102 is skewed i.e. has a skew, the skew of this image. That is, the general-purpose scan software 202 does not support the setting of the skew correction processing. This is because the setting of the skew correction processing is a function uniquely executed by the scanning device 102 manufactured by a predetermined scanner maker. The extension application 204 can extend functions of the general-purpose scan software 202 such that functions which cannot be caused to be executed by the general-purpose scan software 202 can be caused to be executed. Although in the present embodiment, the general-purpose scan software 202 cannot perform the setting of the skew correction processing, and the extension application 204 can extend the function such that the general-purpose scan software 202 can be executed, this is not limitative. For example, the general-purpose scan software 202 can execute part of the setting of the skew correction processing, and the extension application 204 can further extend the execution range by compensating for the shortage of the setting of the skew correction processing.

FIG. 2B is a schematic diagram showing a configuration of the scanning device. As shown in FIG. 2B, the scanning device 102 has a scanner bed 1901 on which a glass stage 1903 is arranged, a plurality of rollers 1902, and a reading sensor 1904 and a reading sensor 1905 that each read an image on a sheet 1906. Each roller 1902 conveys the sheet 1906. In the following description, a direction in which the sheet 1906 is conveyed is sometimes referred to as the sub scanning direction, and a direction orthogonal to the sub scanning direction is sometimes referred to as the main scanning direction. The reading sensor 1904 is fixed to the scanner bed 1901. The reading sensor 1904 is a sensor for reading an image on a surface on the front side of the sheet 1906. The reading sensor 1904 has a light source and a solid-state image sensor, incorporated therein, and acquires a raster image reading signal through the glass stage 1903. When the sheet 1906 reaches a position opposed to the reading sensor 1904, the reading sensor 1904 irradiates light to the front side of the sheet 1906 to form a reflected image on the solid-state image sensor. The reading sensor 1905 is fixed on a side opposite from the reading sensor 1904 across the glass stage 1903. The reading sensor 1905 is a sensor for reading an image on a surface on the reverse side of the sheet 1906. Similar to the reading sensor 1904, the reading sensor 1905 has a light source and a solid-state image sensor, incorporated therein. When the sheet 1906 reaches a position opposed to the reading sensor 1905, the reading sensor 1905 irradiates light to the reverse side of the sheet 1906 to form a reflected image on the solid-state image sensor. In the scanning device 102, it is possible to collectively read the front surface and the reverse surface of the sheet 1906 by using the reading sensor 1904 and the reading sensor 1905 while conveying the sheet 1906. Further, in the scanning device 102, there is a case where the sheet 1906 is conveyed in a skewed state e.g. due to the mounting accuracy or deterioration of the rollers 1902.

FIGS. 2C-A and 2C-B are diagrams each showing an example of a scanned image acquired by the scanning device. FIG. 2C-A shows a scanned image obtained in a case where the skew correction processing has not been executed. FIG. 2C-B shows a scanned image obtained in a case where the skew correction processing has been executed. In the scanned image, denoted by reference numeral 1800A, shown in FIG. 2C-A, an original 1802 is skewed with respect to a margin 1801. The scanned image 1800A is acquired in a case where the sheet 1906 is conveyed in a skewed state, as mentioned above. On the other hand, different from the scanned image 1800A, in the scanned image 1800B shown in FIG. 2C-B, skew of an original 1803 with respect to the margin 1801 has been eliminated. The scanned image 1800B is acquired by executing the skew correction processing even when the sheet 1906 is conveyed in a skewed state.

FIG. 2D is a flowchart of a skew correction process performed by the scanning device. A program for the skew correction process in FIG. 2D is stored e.g. in the ROM 192 of the scanning device 102. The CPU 191 of the scanning device 102 loads this program from the ROM 192 into the RAM 193 and executes the loaded program. Referring to FIG. 2D, in a step S1701, the scanning device 102 acquires a scanned image of an original as a scanned image acquisition target from the reading section 195. Alternatively, the scanning device 102 acquires a scanned image stored in the RAM 193 therefrom.

In a step S1702, the scanning device 102 (CPU 191) detects, i.e. extracts a leading edge (feature amount) of the original, in the scanned image acquired in the step S1701 (extraction step). Specifically, the scanning device 102 forms the scanned image by scanning the image using a 3×3 window, and if a difference between a maximum pixel value and a minimum pixel value in the window is equal to or larger than a threshold value, the scanning device 102 determines a center pixel in the window as an edge pixel. Then, the scanning device 102 sets pixels each determined as an edge pixel first in the sub scanning direction, as the pixels of the leading edge of the original.

In a step S1703, the scanning device 102 calculates a skew angle of the original (scanned image) based on the leading edge (edge information) extracted in the step S1702. Specifically, the scanning device 102 calculates a skew angle based on coordinates of a pixel at a left end edge and coordinates of a pixel at a right end edge out of the pixels of the leading edge.

In a step S1704, the scanning device 102 executes the skew correction processing based on the skew angle calculated in the step S1703. Specifically, the scanning device 102 rotates the scanned image in a direction of canceling the skew angle by an amount corresponding to the skew angle. With this, for example, a scanned image, such as the scanned image 1800B shown in FIG. 2C-B, is obtained. Note that the skew correction processing is not limited to the above-described processing. For example, the scanned image is binarized and scanned from the leading edge of the image in the sub scanning direction, and pixel which become black pixels first can be detected as the pixels of an edge, respectively. Before executing the skew correction processing, filtering processing for emphasizing the edge can be executed for the scanned image. With this, the accuracy of the edge is improved.

The configuration in the case where the extension application 204 is associated with the general-purpose scan software 202 and the scanning device 102 will be described with reference to FIG. 2A-B. As shown in FIG. 2A-B, differently from FIG. 2A-A, the extension application 204 is added. That is, the host computer 101 includes the scan application 201, the general-purpose scan software 202, and the scan function information 203, and further has the extension application 204. The extension application 204 is software for extending the function of the general-purpose scan software 202 and is sometimes simply referred to as the scan software. Note that the extension application 204 is software which is not included (packaged) in the OS in advance. Therefore, the extension application 204 is downloaded from a server (not shown) via the Internet and installed into the host computer 101 according to a user's operation of the host computer 101. Alternatively, when the scanning device 102 is connected to the host computer 101, the extension application 204 can be automatically installed into the host computer 101 based on this connection. Specifically, when the scanning device 102 is connected to the host computer 101, the OS acquires device identification information from the scanning device 102. The OS can download the extension application 204 associated with this device identification information from the server via the Internet and install the downloaded extension application 204. As a result, in the host computer 101, the general-purpose scan software 202 and the extension application 204 are held as control programs independent from each other. Note that the general-purpose scan software 202 and the extension application 204 are sometimes updated and their versions are upgraded, respectively. The processing for updating the general-purpose scan software 202 and the processing for updating the extension application 204 in this case are executed at the same timing or at different timings. Further, a trigger with which the general-purpose scan software 202 is acquired by the host computer 101 and a trigger with which the extension application 204 is acquired by the host computer 101 are the same trigger in one case and the different triggers in the other. Further, in a case where the extension application 204 is installed, the OS associates the extension application 204 with the general-purpose scan software 202 and the scanning device 102.

As shown in FIG. 2A-B, the extension application 204 is capable of exchanging information (transmission and reception of information) with the general-purpose scan software 202 and the scanning device 102, respectively. That is, the extension application 204 is associated with the general-purpose scan software 202 and the scanning device 102. In the present embodiment, the extension application 204 includes a scan setting screen-extending unit 205, a scan function-extending unit 206, an image data-editing unit 207, and a notification unit 209. Further, the extension application 204 includes shared information 208 which can be accessed from each of the scan setting screen-extending unit 205, the scan function-extending unit 206, the image data-editing unit 207, and the notification unit 209. The shared information 208 is a file stored in the external storage device 114 or information stored in the RAM 113. The extension application 204 can write and read the shared information 208 by using an application program interface (API) provided by the OS.

Note that the extension application 204 can terminate the operation as a whole of the extension application 204 in accordance with termination of processing executed by each unit of the scan setting screen-extending unit 205 to the notification unit 209. In this case, the OS starts the extension application 204 whenever a request for causing each unit to execute processing is received. Further, while the processing is being performed any of the scan setting screen-extending unit 205 to the notification unit 209, the extension application 204 can cancel this processing. In this case, a job being processed in a print queue is deleted by the OS. As described above, upon receipt of a print request from a user, the scan application 201 issues a scan instruction to the OS. Further, the scan application 201 can display the scan setting screen. In the configuration shown in FIG. 2A-B, the scan application 201 can display the scan setting screen 300A (detailed setting screen 300C) provided by the scan setting screen-extending unit 205 (the extension application 204). Further, the scan setting screen-extending unit 205 can store detailed settings made by the user in the shared information 208.

The image data-editing unit 207 acquires image data from the scanning device 102. Then, after acquisition of the image data, the image data-editing unit 207 can also edit the acquired image data. Further, the image data-editing unit 207 acquires detailed setting information from the shared information 208 and performs image editing on the image data according to the detailed setting information. The extension application 204 can perform image editing on image data acquired by the general-purpose scan software 202 according to the detailed setting information. Further, also even in the case of the configuration shown in FIG. 2A-B, there is a case where the setting of the skew correction processing is not executed. In this case, the general-purpose scan software 202 can transmit a scan request instruction to the scanning device 102 without using the extension application 204.

The scan function-extending unit 206 can edit the scan function information 203 generated by the general-purpose scan software 202 or the OS. This makes it possible to add a function provided by the extension application 204. Further, it is also possible to add a function which can be executed in the scanning device 102 but cannot be executed by the general-purpose scan software 202 (such as the skew correction function) and add an exclusive relationship between settings of the scan function. The OS starts the scan function-extending unit 206 when the extension application 204 is associated with the scanning device 102 and the general-purpose scan software 202 for the first time. Further, the OS can start the scan function-extending unit 206 at a timing other than this, e.g. at a timing when the OS is started. By starting the scan function-extending unit 206 as described above, the scan function-extending unit 206 can detect, even in a case where a function related to scanning is extended later, the extended function and add the detected function to the scan function information 203.

The notification unit 209 can provide, when an error of the scanning device 102 occurs, a notification indicating this fact. For example, if a reading jam error has occurred in the scanning device 102, the general-purpose scan software 202 detects occurrence of this error. The OS displays a message showing occurrence of the reading jam error as a result of the detection performed by the general-purpose scan software 202, on the display section 119, by using a notification function referred to as the toast notification which is one of the functions of the OS. Note that when the user operates the toast notification, the notification unit 209 is called by the OS, and a user interface screen (UI screen) of the notification unit 209 is displayed. On the user interface screen, a detailed message concerning the reading jam error, a jam resolving method, and so forth can be displayed, for example.

As described above, in the present embodiment, it can be said that the extension application 204 has the following four functions: The first function is the function of displaying a setting screen. This function is executed by the scan setting screen-extending unit 205. The second function is the function of editing image data according to the detailed setting information. This function is executed by the image data-editing unit 207. The third function is the function of extending a function which can be designated by using image data generation software. This function is executed by the scan function-extending unit 206. The fourth function is the function of displaying a screen in response to occurrence of an error in the scanning device 102. This function is executed by the notification unit 209. Note that the configuration of the extension application 204 is not limited to the configuration having these four functions but is preferable to have at least one function of them, and further, the extension application 204 can be configured to further have another function.

FIGS. 3A-A to 3A-C are diagrams each showing an example of a screen displayed on the display section of the scan system. FIG. 3A-A shows the scan setting screen displayed by the scan application 201. FIG. 3A-B shows the detailed setting screen displayed in the case of the configuration in which the extension application 204 is not associated. FIG. 3A-C shows the detailed setting screen displayed in the case of the configuration in which the extension application 204 is associated. Note that a unit or module that displays each screen is not particularly limited. For example, the scan setting screen-extending unit 205 is only required to be configured to be capable of generating a display screen. In this case, the scan setting screen-extending unit 205 transmits the generated display screen to the scan application 201 via the general-purpose scan software 202. The scan application 201 can be configured to display the acquired display screen.

The scan setting screen 300A shown in FIG. 3A-A is a screen on which settings related to scanning to be performed by the scanning device 102 can be made. This scan setting screen 300A includes a control (button) 301, the control 302, a control 303, and a control 304. With the control 301, the user can select and set a scanner device used for reading an original. In the illustrated example in FIG. 3A-A, the scanner device used for reading an original is set to scanner 001 (common driver) by way of example. With the control 302, the user can make detailed settings of the skew correction processing. With the control 303, the user can instruct the scanning device 102 to start scanning. With the control 304, the user can instruct the scanning device 102 to cancel scanning.

When the control 302 is operated in the case of the configuration in which the extension application 204 is not associated, the detailed setting screen 300B shown in FIG. 3A-B is displayed. The detailed setting screen 300B includes a control 305 and a control 306. With the control 305, the user can select and set a scanning location of an original in the scanning device 102, i.e. a placement section where an original to be read is placed. For example, in a case where the scanning device 102 has a scanner bed (original platen glass) and a feeder, as the original scanning location, the feeder is selected in FIG. 3A-B, by way of example. With the control 306, the user can finalize the setting by the control 305. Further, when the control 306 is operated, the screen returns to the scan setting screen 300A shown in FIG. 3A-A.

When the control 302 is operated in the case of the configuration in which the extension application 204 is associated, the detailed setting screen (setting reception screen) 300C shown in FIG. 3A-C is displayed (display control step) Note that the detailed setting screen 300C is a screen displayed together with the scan setting screen 300A, but its display form is not particularly limited. For example, the detailed setting screen 300C can be displayed in a state overlapping the scan setting screen 300A. Further, the detailed setting screen 300C can be displayed adjacent to the scan setting screen 300A or cab be displayed after the scan setting screen 300A once disappears. The detailed setting screen 300C is a screen having a function of receiving a setting of the skew correction processing. Similar to the detailed setting screen 300B, the detailed setting screen 300C includes the control 305 and the control 306. Further, the detailed setting screen 300C additionally includes a control 307. With the control 307, the user can select whether or not to execute the skew correction processing by the scanning device 102. When the control 307 is operated, a list 308 is displayed. The list 308 includes choices of “execute (execution of the skew correction processing)” for selecting to execute the skew correction processing by the scanning device 102, and “not execute (non-execution of the skew correction processing)” for selecting not to execute the skew correction processing by the scanning device 102. Then, by operating the control 306, it is possible to finalize the selection made by the control 307. For example, in a case where “execute” is selected by the control 307 and this selection is finalized, the skew correction processing is instructed to the scanning device 102 according to the original scanning location setting made by the control 305 (instruction step). The scanning device 102 is capable of executing the skew correction processing according to this instruction. In a case where “not execute” is selected by the control 307 and this selection is finalized, the instruction for executing the skew correction processing to the scanning device 102 is inhibited. For example, in a case where the scanned image is not skewed to such a level as will cause concern to the user, it is preferable to select “not execute” by the control 307 for the purpose of increasing the processing speed and the like.

FIGS. 3B-A and 3B-B are diagrams each showing an example (variation) of a screen displayed on the display section of the scan system. Similar to the detailed setting screen 300C, a detailed setting screen 300C′ shown in FIG. 3B-A includes the controls 305 to 307. Further, the detailed setting screen 300C′ additionally includes a control 309. When the control 309 is operated in a state in which “not execute” is selected by the control 307, a preview image 300D shown in FIG. 3B-B is displayed. The preview image 300D includes a preview image 310 and a preview image 311. The preview image 310 is an image before execution of the skew correction processing on a scanned image acquired by scanning. The preview image 311 is an image after execution of the skew correction processing on the scanned image acquired by scanning. With the preview images 310 and 311, the user can confirm, for example, how the preview image 310 is changed after execution of the skew correction processing, on the preview image 311. Further, for example, in a case where a selection can be made between the preview image 310 and the preview image 311 on the preview image 300D, a scanned image corresponding to the selected one can be stored.

Here, a reason why the items included in the detailed setting screen 300B shown in FIGS. 3A-B and the items included in the detailed setting screen 300C shown in FIGS. 3A-C are different will be described. That is, a reason why it is possible to switch whether to display the detailed setting screen 300B or the detailed setting screen 300C will be described. The detailed setting screen 300B and the detailed setting screen 300C are generated based on respective sets of pieces of the scan function information (capabilities information) 203. As mentioned above, the general-purpose scan software 202 does not support the setting of the skew correction processing. Therefore, the skew correction processing setting function cannot be added to the scan function information 203 only by the general-purpose scan software 202. Further, even if the skew correction processing setting function is originally included in the scan function information 203, the general-purpose scan software 202 cannot interpret the skew correction processing setting function included in the scan function information 203. For this reason, the setting of the skew correction processing cannot be displayed on the detailed setting screen. To cope with this, the scan function-extending unit 206 adds the skew correction processing setting function to the scan function information 203. Then, the scan setting screen-extending unit 205 displays the detailed setting screen 300C by referring to the capabilities information. This detailed setting screen 300C is a screen on which the skew correction processing setting can be performed. Note that the detailed setting screen 300C can additionally include a setting item other than the skew correction processing setting.

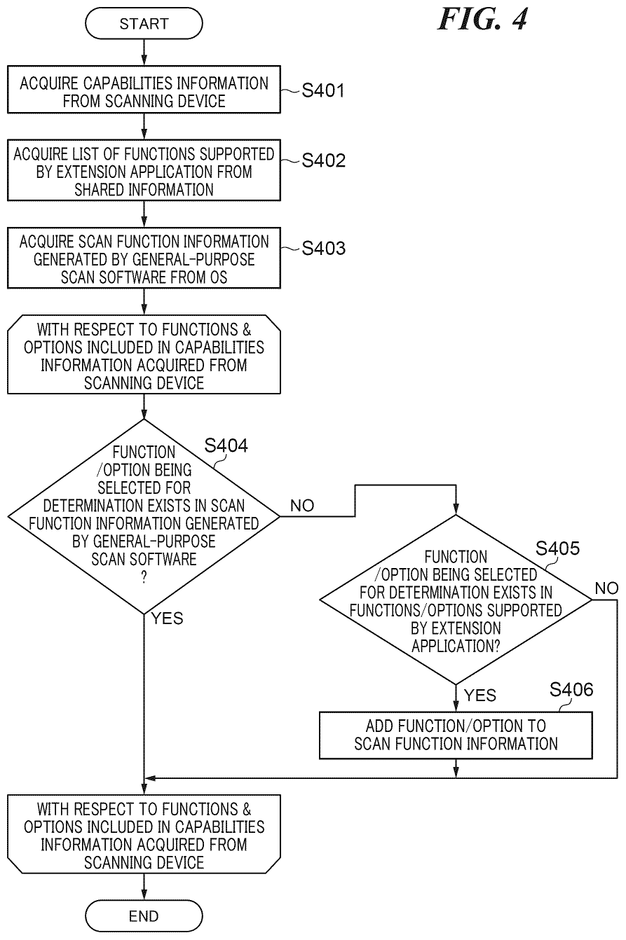

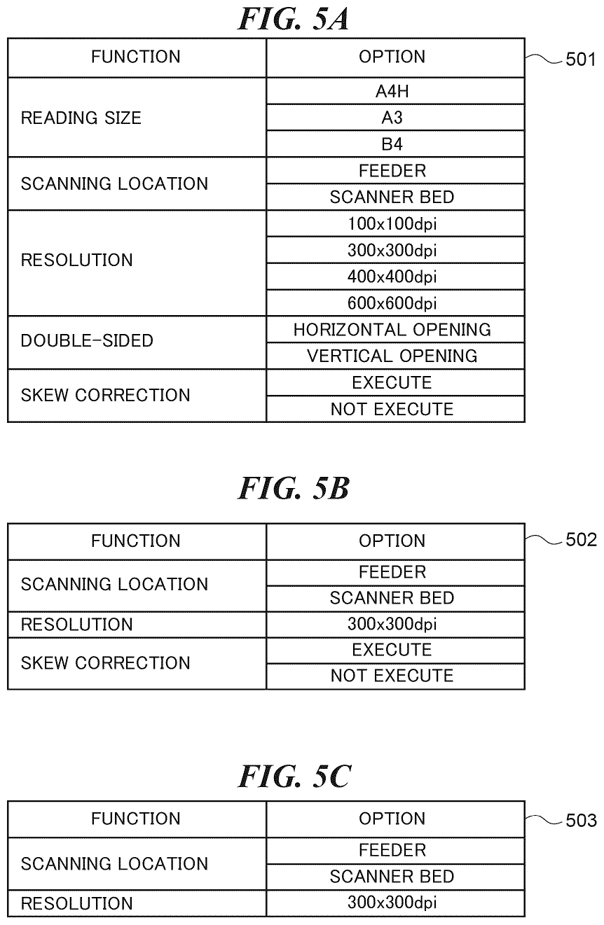

FIG. 4 is a flowchart of a process performed by the scan function-extending unit 206, for editing the scan function information 203. Note that a program for the process in FIG. 4 is executed by the scan function-extending unit 206 under the control of the CPU 111. FIGS. 5A to 5C are diagrams each showing an example of a list of the scan information. Referring to FIG. 4, in a step S401, the scan function-extending unit 206 acquires the capabilities information from the scanning device 102 (acquisition step). This acquisition step is performed before the above-described display control step. The capabilities information is comprised of attribute information indicating the functions which can be designated in the scanning device 102 and settings associated with the attribute information. A table 501 shown in FIG. 5A indicates a list of the capabilities information acquired from the scanning device 102. As shown in the table 501, the functions including the function of the skew correction processing setting and options which can be set for each function can be acquired from the scanning device 102. For example, the function of the skew correction processing setting has options of “execute (execution of the skew correction processing)” and “not execute (non-execution of the skew correction processing)”.

In a step S402, the scan function-extending unit 206 acquires scan functions supported by the extension application 204 from the shared information 208. In the shared information 208, a list of the scan functions supported by the extension application 204 is stored. A table 502 shown in FIG. 5B includes all scan functions which can be executed (supported) by the extension application 204 and the settings of these scan functions. For example, the function of the skew correction processing setting has options of “execute” and “not execute”. Further, the scan functions which can be executed by the extension application 204 are sometimes updated e.g. by the update of the extension application 204.

In a step S403, the scan function-extending unit 206 acquires the scan function information 203 generated by the general-purpose scan software 202 from the OS. The scan function information 203 is generated by the general-purpose scan software 202 based on the capabilities information acquired from the scanning device 102. The scan function information 203 generated by the general-purpose scan software 202 includes only the scan functions which can be executed by the general-purpose scan software 202, out of the capabilities information acquired from the scanning device 102. A table 503 shown in FIG. 5C includes all scan functions which can be executed by the general-purpose scan software 202 and the settings of these scan functions. As shown in the table 503, the scan functions which can be executed by the general-purpose scan software 202 do not include the function of the skew correction processing setting. Therefore, the function of the skew correction processing setting is not included in the scan function information 203. By adding a function and options thereof to the scan function information 203 by using the scan function-extending unit 206, the extension application 204 can compensate for lack of the functions of the general-purpose scan software 202. Further, the scan function-extending unit 206 is also capable of deleting an unnecessary function and options thereof from the scan function information 203 generated by the general-purpose scan software 202.

A step S404, a step S405, and a step S406 are processing operations which are repeatedly executed on the list of the functions included in the capabilities information acquired from the scanning device 102 in the step S401. In the present embodiment, the steps S404, S405, and S406 are repeatedly executed on all of the 13 options included in the table 501.

In the step S404, the scan function-extending unit 206 determines whether or not a function and its option, being currently selected for determination, exist in the scan function information 203 generated by the general-purpose scan software 202. If it is determined in the step S404 that the function and its option, being currently selected for determination, exist in the scan function information 203, the present process is terminated if the option being selected for determination is the final item of the options of all the functions. Alternatively, if the option being selected for determination is not the final item of the options of all the functions, the next item of the options of all the functions is selected, and the step S404 is executed again. On the other hand, if it is determined in the step S404 that the function and its option, being currently selected for determination, do not exist in the scan function information 203, the process proceeds to the step S405. For example, in the present embodiment, “scanner bed” of “scanning location” is included in the table 501, and the “scanner bed” of “scanning location” is also included in the table 503. In this case, it is determined in the step S404 that the function and its option, being currently selected for determination, exist in the scan function information 203. On the other hand, “execute” of “skew correction” is included in the table 501 but is not included in the table 503. In this case, it is determined in the step S404 that the function and its option, being currently selected for determination, do not exist in the scan function information 203.

In the step S405, the scan function-extending unit 206 determines whether or not the function and its option, being currently selected for determination, exists in the functions and their options supported by the extension application 204. If it is determined in the step S405 that the function and its option being currently selected for determination exists, the process proceeds to the step S406. On the other hand, if it is determined in the step S405 that the function and its option being currently selected for determination does not exist, similar to the case where the answer to the question of the step S404 is affirmative (YES), the present process is terminated if the option being selected for determination is the final item of the options of all the functions. Alternatively, if the option being selected for determination is not the final item of the options of all the functions, the next item of the options of all the functions is selected, and the step S404 is executed again. For example, in the present embodiment, in a case where the function and its option being currently selected for determination is “execute” of “skew correction”, since the “execute” of “skew correction” also exists in the table 502, it is determined in the step S405 that the function and its option being currently selected for determination exists.

In the step S406, the scan function-extending unit 206 adds the function and its option being currently selected for determination to the scan function information 203. After execution of the step S406, similar to the case where the answer to the question of the step S404 is affirmative (YES), the present process is terminated if the function and its option being selected for determination is the final item of the options of all the functions. Alternatively, if the function and its option being selected for determination is not the final item of the options of all the functions, the next item of the options of all the functions is selected, and the step S404 is executed again.

As described above, the extension application 204 can add, to the scan function information 203, a function and its option which is not supported by the general-purpose scan software 202 but is supported by the scanning device 102, and at the same time is supported by the extension application 204. Then, the capabilities information is generated based on the scan function information 203 edited by this addition processing. Further, by generating a display screen based on the resulting capabilities information, the scan setting screen-extending unit 205 can extend the function not supported by the general-purpose scan software 202 and display the detailed setting screen 300C shown in FIG. 3A-C.

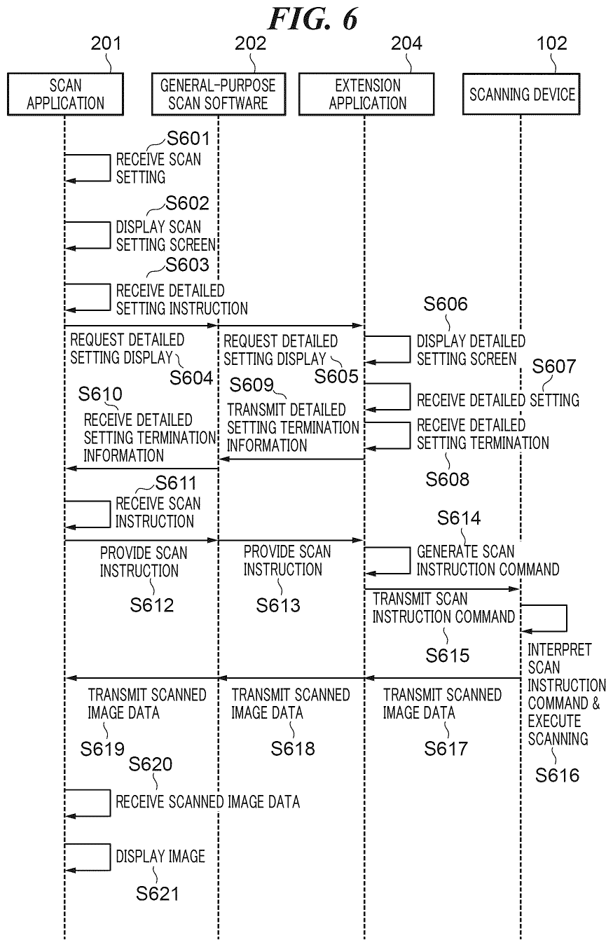

FIG. 6 is a sequence diagram showing a process executed between the scan application 201, the general-purpose scan software 202, the extension application 204, and the scanning device 102 after the scan application 201 receives a scan setting instruction. Processing operations performed by the scan application 201, the general-purpose scan software 202, and the extension application 204 are executed by the CPU 111 of the host computer 101. A processing program for the operations is stored in the external storage device 114. The CPU 111 loads the processing program from the external storage device 114 into the RAM 113 and executes the loaded processing program. Further, processing operations performed by the scanning device 102 are executed by the CPU 191 of the scanning device 102. A processing program for the operations is stored in the external storage device 199. The CPU 191 loads the processing program from the external storage device 199 into the RAM 193 and executes the loaded processing program. Further, the software configuration of the scan system 1000 is shown in FIG. 2A-B.

Referring to FIG. 6, in a step S601, the scan application 201 receives the scan setting instruction by a user. The user can instruct the scan setting to the scan application 201 by operating e.g. the pointing device 117 and the keyboard 118.

In a step S602, the scan application 201 displays the scan setting screen 300A shown in FIG. 3A-A on the display section 119.

In a step S603, the scan application 201 receives a detailed setting instruction provided by the user. The user can instruct the detailed setting by operating e.g. the pointing device 117 and the keyboard 118 to select the control 302 on the scan setting screen 300A.

In a step S604, the scan application 201 requests the general-purpose scan software 202 to display the detailed setting.

In a step S605, the general-purpose scan software 202 requests the extension application 204 to display the detailed setting.

In a step S606, the scan setting screen-extending unit 205 of the extension application 204 displays the detailed setting screen 300C shown in FIG. 3A-C on the display section 119 in response to the request received in the step S605. As described hereinabove, the setting of the skew correction processing is added to the scan function information 203 by the scan function-extending unit 206. The scan setting screen-extending unit 205 can display the detailed setting screen 300C by referring to the capabilities information generated based on the scan function information 203 to which the setting of the skew correction processing has been added. Note that in a case where a setting item of resolution of an image and the like are included, these setting items can be displayed as required, or can be inhibited from being displayed or be displayed in a grayed-out state.

In a step S607, the scan setting screen-extending unit 205 receives the detailed setting input by the user on the detailed setting screen 300C. Note that, here, on the detailed setting screen 300C, “feeder” of the scanning location is selected by the control 305, and “execute” of the skew correction processing setting is selected by the control 307 by way of example (see FIG. 3A-C). In this setting state, the scan setting screen-extending unit 205 receives the operation of the control 306 on the detailed setting screen 300C, performed by the user. With this, the CPU 111 stores the setting state on the detailed setting screen 300C in the RAM 113.

In a step S608, the scan setting screen-extending unit 205 receives termination of the detailed setting performed by the user based on the operation of the control 306 in the step S607. The user can instruct termination of the detailed setting by operating e.g. the pointing device 117 and the keyboard 118 to select the control 306. With this, the setting state on the detailed setting screen 300C is written into the scan function information 203. Note that the information written into the scan function information 203 can also include, for example, the information inhibited from being displayed or displayed in the grayed-out state.

In a step S609, the extension application 204 transmits detailed setting termination information to the effect that the detailed setting in the S608 has been terminated, to the general-purpose scan software 202.

In a step S610, the general-purpose scan software 202 receives the detailed setting termination information sent from the extension application 204 in the step S609. Then, the general-purpose scan software 202 transmits this detailed setting termination information to the scan application 201.

In a step S611, the scan application 201 receives a scan instruction provided by the user. The user can instruct scanning by operating e.g. the pointing device 117 and the keyboard 118 to select the control 303 on the scan setting screen 300A (see FIG. 3A-A).

In a step S612, the scan application 201 provides the scan instruction received in the step S611 to the general-purpose scan software 202.

In a step S613, the general-purpose scan software 202 receives the scan instruction provided in the step S612. Then, the general-purpose scan software 202 provides this scan instruction to the extension application 204.

In a step S614, the extension application 204 receives the scan instruction provided in the step S613. Then, the extension application 204 generates a scan instruction command based on the scan function information 203 in which the setting state on the detailed setting screen 300C has been written in the step S608. Note that this scan instruction command includes the setting information of the skew correction processing (skew correction processing setting of “execute”) received on the detailed setting screen 300C. Further, there is a case where the information inhibited from being displayed or displayed in the grayed-out state in the step S608 has not been written into the scan function information 203. In this case, in the step S614, the extension application 204 can add the information which has not been written into the scan function information 203 to the scan instruction command or the information can be set as the default value.

In a step S615, the extension application 204 transmits the scan instruction command generated in the step S614 to the scanning device 102.

In a step S616, the input/output interface 198 of the scanning device 102 receives the scan instruction command transmitted in the step S615. Then, the reading section 195 of the scanning device 102 interprets the scan instruction command and executes scanning under the conditions set on the detailed setting screen 300C. As a result, image data on which the skew correction processing has been performed is obtained as the scanned image data (read image data).

In a step S617, the input/output interface 198 of the scanning device 102 transmits the scanned image data obtained in the step S616 to the extension application 204.

In a step 618, the extension application 204 receives the scanned image data transmitted in the step S617. Then, the extension application 204 transmits this scanned image data to the general-purpose scan software 202.

In a step S619, the general-purpose scan software 202 receives the scanned image data sent in the step S618. Then, the general-purpose scan software 202 transmits this scanned image data to the scan application 201.

In a step S620, the scan application 201 receives the scanned image data sent in the step S619.

In a step S621, the scan application 201 displays the scanned image data received in the step S620 on the display section 119. As a result, the scanned image data, i.e. the image data on which the skew correction processing has been performed in the step S616 is displayed on the display section 119 as a preview image.

As described above, in the scan system 1000, even in a case where the general-purpose scan software 202 does not support the setting of the skew correction processing, it is possible to execute the setting of the skew correction processing by using the extension application 204. This enables the scanning device 102 to perform scanning under settings of the skew correction processing, and as a result, the scanned image becomes an image of which the skew has been corrected. Note that in the description given with reference to FIG. 6, the detailed setting screen 300C shown in FIG. 3A-C is displayed by assuming that the software configuration of the scan system 1000 is as shown in FIG. 2B, but this is not limitative. For example, in a case where a request for displaying the detailed setting is provided to the general-purpose scan software 202, the general-purpose scan software 202 displays the detailed setting screen 300B shown in FIG. 3A-B. In this case, after the control 306 on the detailed setting screen 300B is operated, the general-purpose scan software 202 requests the extension application 204 to display an additional detailed setting screen. Then, the extension application 204 can additionally display a detailed setting screen on which the setting of the skew correction processing can be made.

Further, in the step S613, the scan instruction is provided from the general-purpose scan software 202 to the extension application 204, but this is not limitative. For example, the scan instruction can be provided from the scan application 201 to the extension application 204. Further, a control for a scan instruction can be disposed on the detailed setting screen 300C. In this case, when the user operates the control for a scan instruction, the scan instruction is provided to the extension application 204. Further, the scanned image data can be transmitted from the scanning device 102 to the scan application 201 via the extension application 204 without via the general-purpose scan software 202. Further, the scanned image data can be transmitted from the scanning device 102 directly to the scan application 201. Further, the scan system 1000 can be configured such that the scanned image data is stored in the external storage device 114, and only information of a file path as storage destination can be sent and received. Further, in the scan system 1000, in a case where there are a plurality of scanned image data, all the scanned image data can be collectively transmitted, or each scanned image data can be transmitted whenever the scanned image data is obtained.

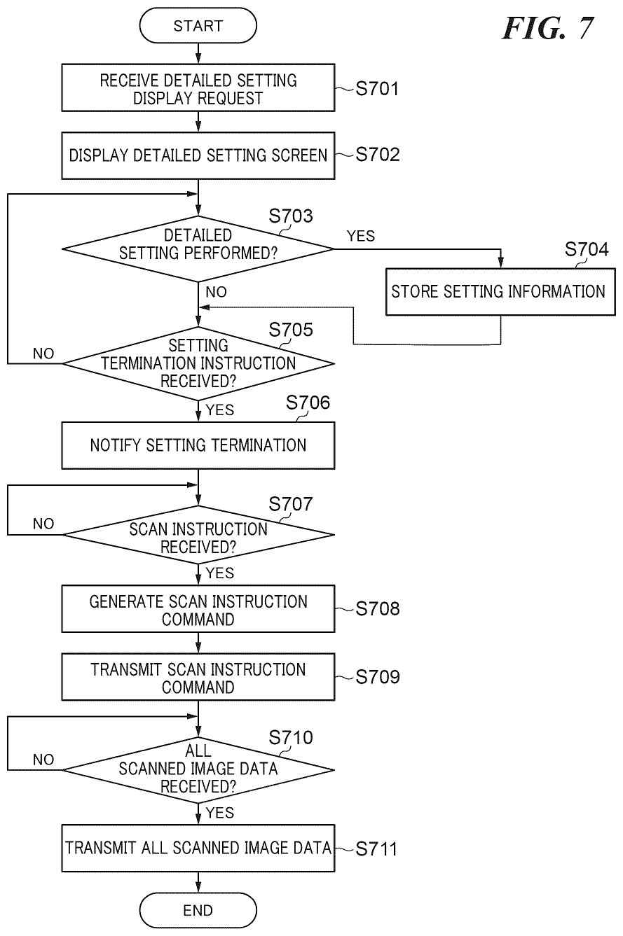

FIG. 7 is a flowchart of the process performed by the extension application. A program for executing the process in FIG. 7 is stored in the external storage device 114. The CPU 111 can execute the present process by loading the program from the external storage device 114 into the RAM 113. Referring to FIG. 7, in a step S701, the extension application 204 receives the request for displaying the detailed setting (see the step S605) from the general-purpose scan software 202.

In a step S702, the scan setting screen-extending unit 205 of the extension application 204 displays the detailed setting screen 300C shown in FIG. 3A-C on the display section 119 in response to the detailed setting display request received in the step S701. As described hereinabove, the setting of the skew correction processing is added to the scan function information 203. The scan setting screen-extending unit 205 can display the detailed setting screen 300C by referring to the capabilities information generated based on the scan function information 203.

In a step S703, the scan setting screen-extending unit 205 determines whether or not the detailed setting has been performed on the detailed setting screen 300C, i.e. whether or not a selection operation has been performed on the control 305 or the control 307. If it is determined in the step S703 that the detailed setting has been performed, the process proceeds to a step S704. On the other hand, if it is determined in the step S703 that the detailed setting has not been performed, the process proceeds to a step S705.

In the step S704, the scan setting screen-extending unit 205 stores (saves) the setting state (setting information) on the detailed setting screen 300C in the RAM 113. After execution of the step S704, the process proceeds to the step S705.

In the step S705, the scan setting screen-extending unit 205 determines whether or not a detailed setting termination instruction has been provided on the detailed setting screen 300C, i.e. whether or not the control 306 has been operated. If it is determined in the step S705 that the detailed setting termination instruction has been provided, the process proceeds to a step S706. On the other hand, if it is determined in the step S705 that the detailed setting termination instruction has not been provided, the process returns to the step S703 to sequentially execute the step S703 et seq.

In the step S706, the extension application 204 notifies the general-purpose scan software 202 of the detailed setting termination instruction provided in the step S705.

In a step S707, the extension application 204 determines whether or not a scan instruction has been provided from the general-purpose scan software 202 (see the step S613). If it is determined in the step S707 that a scan instruction has been provided, the process proceeds to a step S708. On the other hand, if it is determined in the step S707 that a scan instruction has not been provided, the process remains in the step S707.

In the step S708, the extension application 204 generates a scan instruction command based on the scan function information 203 in which the setting state on the detailed setting screen 300C has been written. Further, as the method of generating a scan instruction command, for example, a method of extending a standard protocol command can be used. Further, as this extension method, for example, a method of describing a dedicated command in an extension area of the standard protocol command can be used. The other extension methods include a method of adding a custom standard command to the end of a standard protocol command, a method of overwriting the standard protocol command with a custom command system, by the extension application 204, and so forth. Further, in a case where an instruction is provided from the extension application 204, instruction and communication can be performed according to a protocol unique to a maker, regardless of the standard protocol.

In a step S709, the extension application 204 transmits the scan instruction command generated in the step S708 to the scanning device 102.

In a step S710, the extension application 204 determines whether or not all of the scanned image data (see the step S617) have been received from the scanning device 102. If it is determined in the step S710 that all of the scanned image data have been received, the process proceeds to a step S711. On the other hand, if it is determined in the step S710 that all of the scanned image data have not been received, the process remains in the step S710.

In the step S711, the extension application 204 transmits all the scanned image data received from the scanning device 102 to the general-purpose scan software 202, followed by terminating the present process.

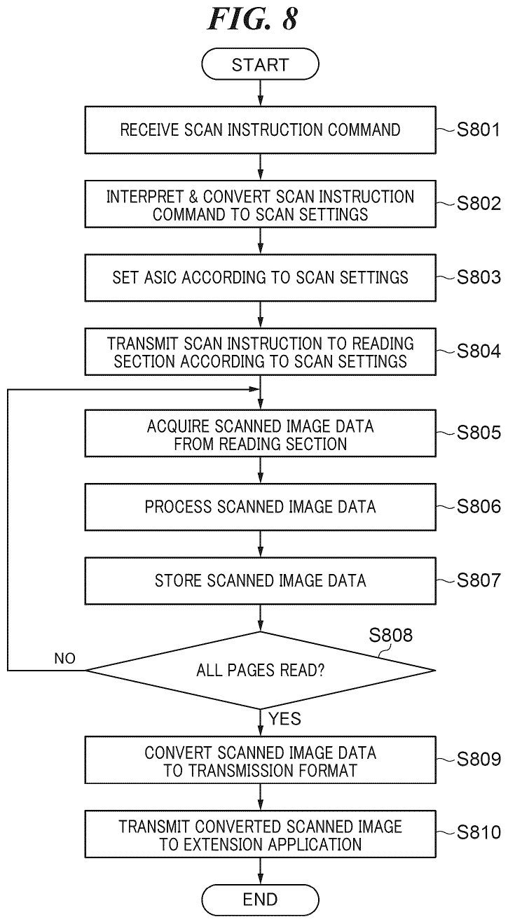

FIG. 8 is a flowchart of the process performed by the scanning device 102. A program for executing the process in FIG. 8 is stored in the external storage device 199. The CPU 191 can execute the present process by loading the program from the external storage device 199 into the RAM 192. Referring to FIG. 8, in a step S801, the CPU 191 receives the scan instruction command (see the step S615) from the extension application 204.

In a step S802, the CPU 191 interprets the scan instruction command received in the step S801. Then, the CPU 191 converts the scan instruction command to scan settings for enabling the scanning device 102 to execute scan processing, i.e. settings for enabling execution of scanning under the conditions (skew correction processing setting of “execute”) set on the detailed setting screen 300C.

In a step S803, the CPU 191 determines an application specific integrated circuit (ASIC) of the image processor 190, which is to be used to execute scanning according to the settings (scan settings) obtained in the step S802 and performs setting of the ASIC.

In a step S804, the CPU 191 transmits a reading instruction based on the scan settings to the reading section 195.

In a step S805, the CPU 191 acquires scanned image data from the reading section 195.

In a step S806, the CPU 191 controls the image processor 190 to execute image processing on the scanned image data acquired in the step S805. As the image processing, in the present embodiment, the skew correction processing is performed, for example.

In a step S807, the CPU 191 saves the scanned image data obtained in the step S806 in the external storage device 199.

In a step S808, the CPU 191 determines whether or not the scan processing has been completed with respect to all of the pages of the original to be read, i.e. scanned. If it is determined in the step S808 that the scan processing has been completed, the process proceeds to a step S809. On the other hand, if it is determined in the step S808 that the scan processing has not been completed, the process returns to the step S805, to sequentially execute the step S805 et seq.

In the step S809, the CPU 191 controls the image processor 190 to convert the scanned image data saved in the step S807 to a transmission format. In the present embodiment, the transmission format is not included in the scan instruction command received in the step S801. Therefore, the scanned image data is converted to JPEG as the default setting of the scanning device 102, but this is not limitative.

In a step S810, the CPU 191 controls the input/output interface 198 to transmit the scanned image data converted in the step S809 to the extension application 204, followed by terminating the present process. Note that in the present embodiment, the description has been given of the case where an original is read (scanned) on the feeder, and the skew correction processing is executed, but it is also possible to execute the skew correction processing on an original read (scanned) on the scanner bed. In this case, first, a pressure plate (not shown) is moved down in a state in which an original is placed on the glass stage 1903. With this, the original is fixed on the glass stage 1903. Next, the scanning location set on the control 305 on the detailed setting screen 300C shown in FIG. 3A-C is changed to “scanner bed”, the setting on the control 307 is changed to “execute”, and then scanning is executed. Further, although in the present embodiment, in a case where there are a plurality of image data, all the image data are received and then collectively transmitted to the extension application 204, this is not limitative, but, for example, each image data can be transmitted to the extension application 204 whenever the scanned image data is received.

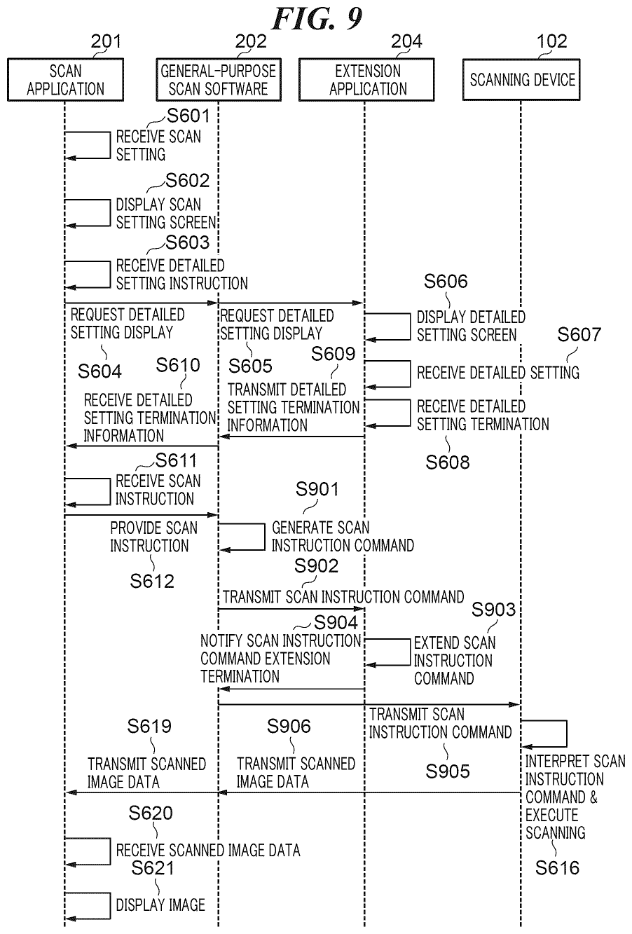

Next, a second embodiment will be described below with reference to FIG. 9, but the description will be given mainly of different points from the above-described embodiment, and description of the same points is omitted.

FIG. 9 is a sequence diagram showing a process executed between the scan application 201, the general-purpose scan software 202, the extension application 204, and the scanning device 102, after the scan application receives a scan setting instruction, in the second embodiment. In the sequence diagram shown in FIG. 9, differently from the sequence diagram shown in FIG. 6, after execution of the step S612, steps S901 to S905 are sequentially executed in place of the steps S613 to S615. Further, after execution of the step S616, a step S906 is executed in place of the steps S617 and S618. Referring to FIG. 9, in the step S901, the general-purpose scan software 202 receives the scan instruction provided in the step S612. Then, the general-purpose scan software 202 generates a scan instruction command based on the scan function information 203 in which the setting state on the detailed setting screen 300C has been written in the step S608. Note that this scan instruction command does not include functions which are not supported by the general-purpose scan software 202.

In the step S902, the general-purpose scan software 202 transmits the scan instruction command generated in the step S901 to the extension application 204.

In the step S903, the extension application 204 receives the scan instruction command sent in the step S902. Then, the extension application 204 adds an instruction command of a function which is not supported by the general-purpose scan software 202 and changes an existing instruction, for the scan instruction command. With this, the function of the scan instruction command is extended. Specifically, since the setting of the skew correction processing is not included in the scan instruction command generated by the general-purpose scan software 202 in the step S901, the setting of the skew correction processing is added in the step S903.

In the step S904, the extension application 204 notifies the general-purpose scan software 202 that extension of the function of the scan instruction command in the S903 is completed. Further, the extension application 204 transmits the scan instruction command in which the function has been extended in the step S903 to the general-purpose scan software 202.

In the step S905, the general-purpose scan software 202 receives the scan instruction command sent in the step S904. Then, the general-purpose scan software 202 transmits this scan instruction command to the scanning device 102.

In the step S906, the input/output interface 198 of the scanning device 102 transmits the scanned image data obtained in the step S616 to the general-purpose scan software 202. With this, the general-purpose scan software 202 can receive this scanned image data.

As described above, in the present embodiment, it is possible to transmit the scan instruction command in which the function of setting the skew correction processing has been extended by the extension application 204 to the scanning device 102 via the general-purpose scan software 202. As a result, it is possible to perform scanning under settings of the skew correction processing.

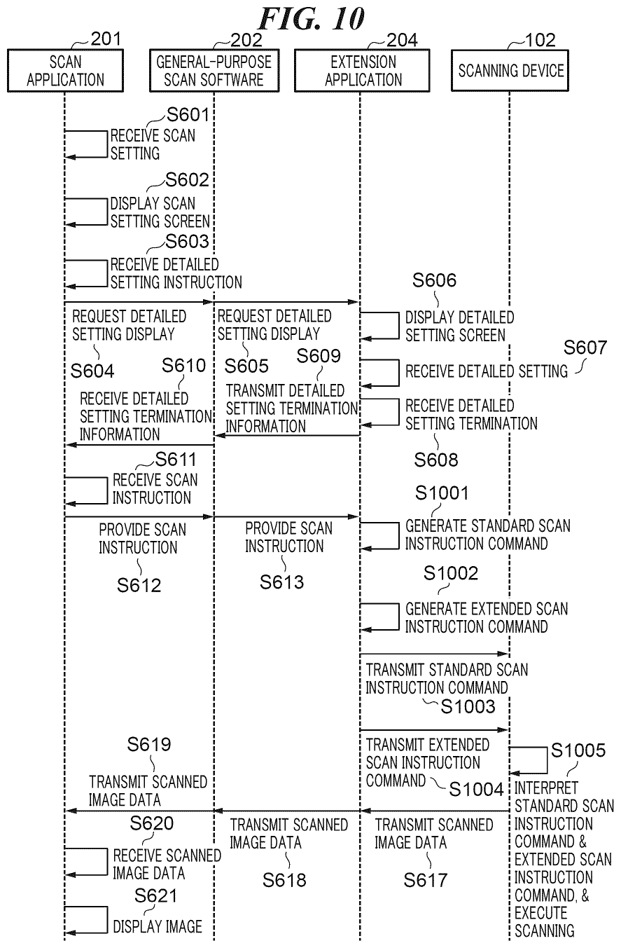

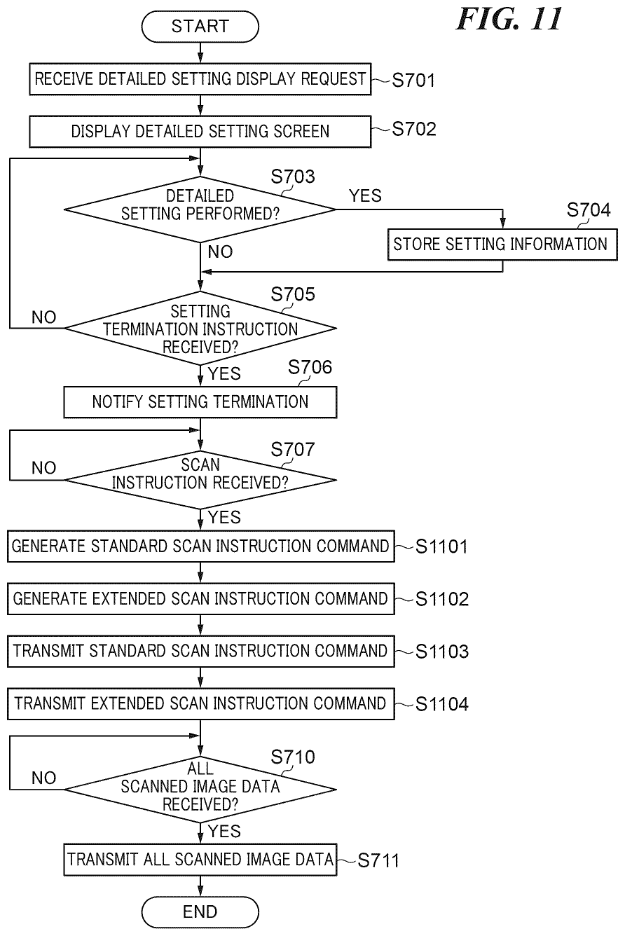

A third embodiment will be described below with reference to FIGS. 10 and 11, but the description will be given mainly of different points from the above-described embodiments, and description of the same points is omitted.

FIG. 10 is a sequence diagram showing a process executed between the scan application 201, the general-purpose scan software 202, the extension application 204, and the scanning device 102, after the scan application receives a scan setting instruction in the third embodiment. In the sequence diagram shown in FIG. 10, differently from the sequence diagram shown in FIG. 6, after execution of the step S613, steps S1001 to S1005 are sequentially executed in place of the steps S614 to S616. As shown in FIG. 10, in the step S1001, the extension application 204 receives the scan instruction provided in the step S613. Then, the extension application 204 generates a standard scan instruction command according to the standard protocol. Note that this scan instruction command does not include functions which are not supported by the standard protocol.

In the step S1002, the extension application 204 generates an extended scan instruction command with respect to the function which is supported only by the extension application 204.

In the step S1003, the extension application 204 transmits the standard scan instruction command generated in the step S1001 to the scanning device 102.

In the step S1004, the extension application 204 transmits the extended scan instruction command generated in the step S1002 to the scanning device 102.

In the step S1005, the input/output interface 198 of the scanning device 102 receives the standard scan instruction command transmitted in the step S1003 and the extended scan instruction command transmitted in the step S1004. Then, the reading section 195 of the scanning device 102 interprets the standard scan instruction command and the extended scan instruction command, respectively, and executes scanning. With this, as the scanned image data, image data on which the skew correction processing has been executed is obtained.

As described above, in the present embodiment, the function of setting the skew correction processing is not extended with respect to the standard scan instruction command, and it is possible to cope with the function of setting the skew correction processing, supported only by the extension application 204, by using another scan instruction command. With this, it is possible to perform scanning under settings of the skew correction processing.

FIG. 11 is a flowchart of the process performed by the extension application. In the flowchart shown in FIG. 11, differently from the flowchart shown in FIG. 7, steps S1101 to S1104 are sequentially executed in place of the steps S708 and S709. As shown in FIG. 11, in the step S1101, the extension application 204 generates a standard scan instruction command according to the standard protocol.

In the step S1102, the extension application 204 generates an extended scan instruction command with respect to a function which is not supported by the standard protocol but supported only by the extension application 204.

In the step S1103, the extension application 204 transmits the standard scan instruction command generated in the step S1101 to the scanning device 102.

In the step S1104, the extension application 204 transmits the extended scan instruction command generated in the step S1102 to the scanning device 102. After execution of the step S1104, the process proceeds to the step S710.

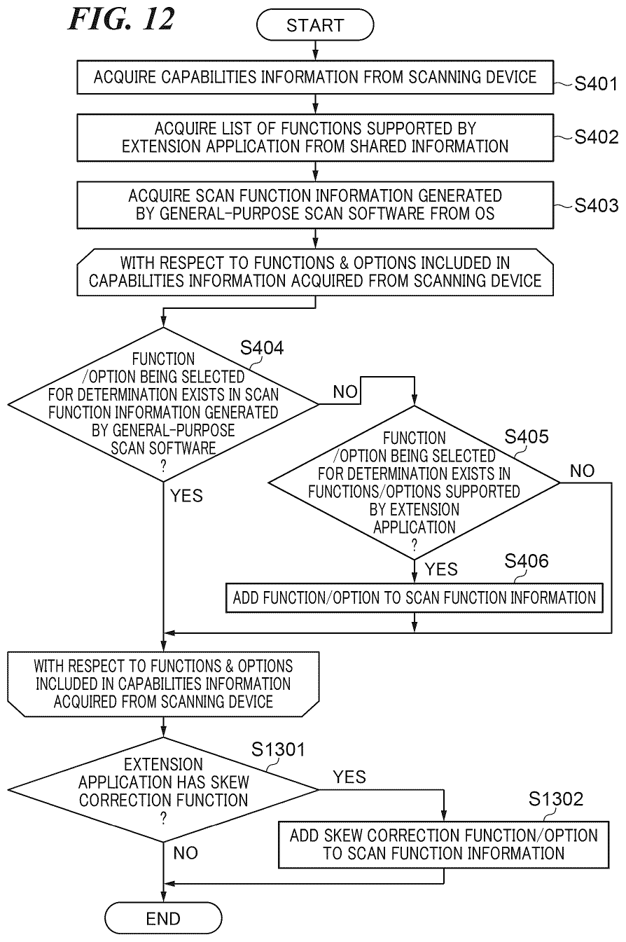

A fourth embodiment will be described below with reference to FIGS. 12 to 14, but the description will be given mainly of different points from the above-described embodiments, and description of the same points is omitted. In the first embodiment, the extension application 204 performs the setting of the skew correction processing in cooperation with the general-purpose scan software 202. Then, execution of the skew correction processing according to the settings made thereby is instructed to the scanning device 102. With this, the scanning device 102 is capable of executing the skew correction processing. Thus, in the first embodiment, the extension application 204 causes, in cooperation with the general-purpose scan software 202, the scanning device 102 to execute the skew correction processing.

However, some types of the scanning device 102 are not capable of executing the skew correction processing. In this case, even when the extension application 204 instructs execution of the skew correction processing, it is impossible to cause the scanning device 102 to execute the skew correction processing. In view of with, in the present embodiment, whether or not the scanning device 102 is capable of executing the skew correction processing is determined based on the capabilities information of the scanning device 102. As a result of this determination, if it is determined that the scanning device 102 is capable of executing the skew correction processing, the extension application 204 causes the scanning device 102 to execute the skew correction processing. On the other hand, if it is determined that the scanning device 102 is incapable of executing the skew correction processing, the extension application 204 executes the skew correction processing. With this, even in a case where the scanning device 102 is incapable of executing the skew correction processing, it is possible to provide the skew correction processing to the user.

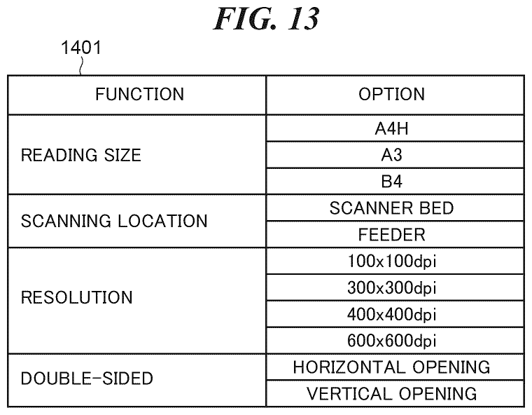

FIG. 12 is a flowchart of a process performed for editing the scan function information 203, by the scan function-extending unit 206 in the fourth embodiment. Note that a program for the process in FIG. 12 is executed by the scan function-extending unit 206 under the control of the CPU 111. Further, the process in FIG. 12 is configured by adding steps S1301 and S1302 to the process in FIG. 4. FIG. 13 is a diagram showing an example of a list of the capabilities information of the scanning device. As shown in FIG. 12, in a case where the process for repeating the steps S404 to S406 is terminated, the process proceeds to the step S1301. A table 1401 in FIG. 13 shows a list of the capabilities information of the scanning device 102. This table 1401 includes, as the capabilities information, information related to a reading size, information related to a scanning location, information related to resolution, and information related to double-sided printing, but differently from the table 501 in FIG. 5A, information related to the skew correction processing is not included. Accordingly, it is known that the scanning device 102 is incapable of executing the skew correction processing. Therefore, in the scan function information 203 after execution of the processing operations in the steps S404 to S406, the skew correction function is not added.

As shown in FIG. 12, in the step S1301, the scan function-extending unit 206 determines whether or not the extension application 204 has the skew correction function. If it is determined in the step S1301 that the extension application 204 has the skew correction function, the process proceeds to the step S1302. On the other hand, if it is determined in the step S1301 that the extension application 204 does not have the skew correction function, the process is terminated. As described above, since the extension application 204 has the skew correction function, the process proceeds to the step S1302.

In the step S1302, the scan function-extending unit 206 adds the information related to the skew correction processing to the scan function information 203.

As described above, the extension application 204 can add, to the scan function information 203, a function which is not supported by the general-purpose scan software 202 but supported by the scanning device 102, and at the same time is supported by the extension application 204. Then, the scan function-extending unit 206 determines whether or not the extension application 204 has the skew correction function. As a result of this determination, if it is determined that extension application 204 has the skew correction function, the skew correction function is added to the scan function information 203. With this addition processing, even when the scanning device 102 is incapable of executing the skew correction processing, the capabilities information is generated based on the scan function information 203 to which the skew correction processing has been added. The extension application 204 can display the detailed setting screen 300C shown in FIG. 3A-C by generating a display screen based on this capabilities information.

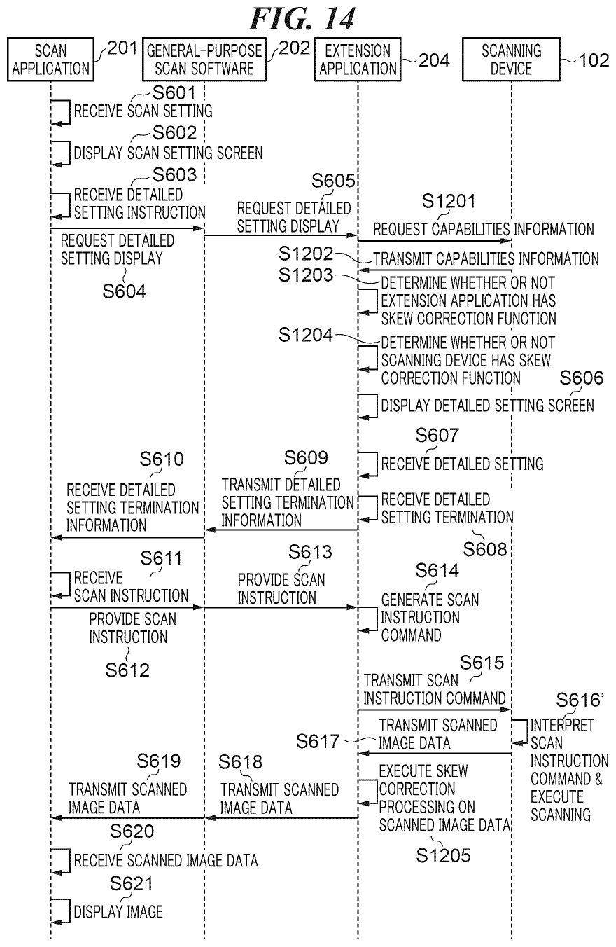

FIG. 14 is a sequence diagram showing a process executed between the scan application 201, the general-purpose scan software 202, the extension application 204, and the scanning device 102 after the scan application receives a scan setting instruction. In the sequence diagram shown in FIG. 14, differently from the sequence diagram shown in FIG. 6, steps S1201 to S1204 are sequentially executed between the steps S605 and S606. Further, a step S1205 is executed between the steps S617 and S618. Referring to FIG. 14, in the step S1201, the scan function-extending unit 206 of the extension application 204 requests the capabilities information to the scanning device 102.

In the step S1202, the scanning device 102 transmits the capabilities information to the scan function-extending unit 206 in response to the capabilities information request received in the step S1201. With this, the scan function-extending unit 206 acquires the capabilities information from the scanning device 102.

In the step S1203, the scan function-extending unit 206 acquires a list of the scan functions supported by the extension application 204 from the shared information 208 and determines whether or not the skew correction function is included in this list.

In the step S1204, the scan function-extending unit 206 determines, based on the capabilities information acquired in the step S1202, whether or not the scanning device 102 has the skew correction function. In the present embodiment, the scanning device 102 does not have the skew correction function, and hence it is determined in the step S1204 that the scanning device 102 does not have the skew correction function. Note that if it is determined in the step S1204 that the scanning device 102 has the skew correction function, execution of the step S1205 is omitted. This is because, in general, the scanning device 102 is capable of executing the skew correction processing at higher speed than the image data-editing unit 207. Specifically, the scanning device 102 uses the ASIC, whereby it is capable of executing the skew correction processing at higher speed than the image data-editing unit 207.

In the step S1205, the image data-editing unit 207 of the extension application 204 executes the skew correction processing on the image data received from the scanning device 102 according to the setting of the skew correction processing, which is received on the detailed setting screen 300C (execution step). As a result, image data on which the skew correction processing has been executed (corrected image data) is obtained, i.e. generated. Note that, different from the step S616 in the first embodiment, in a step S616′ in the present embodiment, the skew correction processing is not executed.

Then, in the step S618 after execution of the step S1205, the extension application 204 transmits the image data obtained in the step S1205, i.e. a result of execution in the execution step, to the general-purpose scan software 202 (transmission step).

As described above, in the present embodiment, even when the scanning device 102 is incapable of executing the skew correction processing, it is possible to execute the skew correction processing by using the extension application 204.

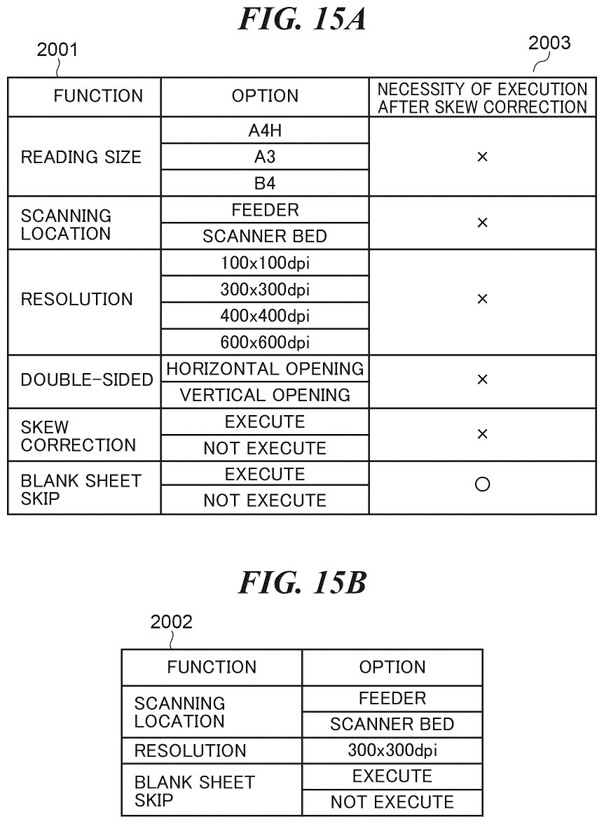

A fifth embodiment will be described below with reference to FIGS. 15A to 17, but the description will be given mainly of different points from the above-described embodiments, and description of the same points is omitted. The image processing operations to be performed concerning image data include one that is preferably executed after the skew correction processing. Such image processing is not particularly limited, and is, for example, blank sheet skip processing. The blank sheet skip processing refers to processing for determining, in a case where an original sheet in a blank state is included in a plurality of original sheets, image data of the original sheet in the blank state in all scanned image data, and eliminating the determined image data from the scanned image data. For example, let it be assumed that there are three pages of original sheets, and the first page and the third page of these original sheets have images formed thereon, but the second page of the original sheets is in the blank state. In this case, as the scanned image data, the image data of the first and third pages as the original sheets each having the image are captured, and the image data of the second page as the original sheet in the blank state is excluded. Note that in the blank sheet skip processing, a histogram, a variance value, and/or the like are/is calculated in specific areas of an image, to thereby determine whether or not an original is in the blank state. Therefore, in a case where the skew correction processing has not been executed, the determination on whether an original is in the blank state can be performed on a sheet including areas outside the original and edges of the sheet, and as a result, the determination can be erroneously performed.

FIGS. 15A and 15B are diagrams each showing an example of a list of the scan information in the fifth embodiment. A table 2001 shown in FIG. 15A includes all pieces of capabilities information which can be executed by the extension application 204. Particularly, in the present embodiment, the blank sheet skip function is included in the table 2001. Further, the table 2001 also includes information 2003 related to whether or not to execute each function after execution of the skew correction processing. In the information 2003, a mark “o” set for the blank sheet skip function indicates the blank sheet skip function is to be executed after execution of the skew correction processing, whereas a mark “x” in the information 2003 indicates that the function is not required to be executed after execution of the skew correction processing. A table 2002 shown in FIG. 15B includes the capabilities information of the scanning device 102. Particularly, in the present embodiment, similar to the table 2001, the table 2002 includes the blank sheet skip function.

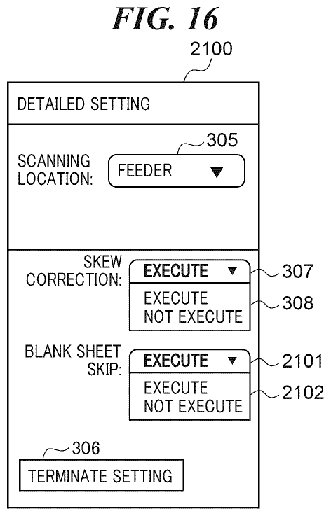

FIG. 16 is a diagram showing an example of a screen displayed on the display section of the scan system. Similar to the detailed setting screen 300C, a detailed setting screen 2100 shown in FIG. 16 includes the controls 305 to 307. Further, the detailed setting screen 2100 additionally includes a control 2101. With the control 2101, the user can select whether or not to execute the blank sheet skip processing. When the control 2101 is operated, a list 2102 is displayed. The list 2102 includes “execute” indicating that the blank sheet skip processing is to be executed and “not execute” indicating that the blank sheet skip processing is not to be executed. Then, when the control 306 is operated, it is possible to determine a selection made on the control 307 and a selection made on the control 2101. For example, in a case where “execute” is selected on the control 2101, and this selection is determined, the blank sheet skip processing is instructed. In a case where “not execute” is selected on the control 2101, and this selection is determined, an instruction for executing the blank sheet skip processing is inhibited. Thus, in the present embodiment, the blank sheet skip processing can be set by using the extension application 204.

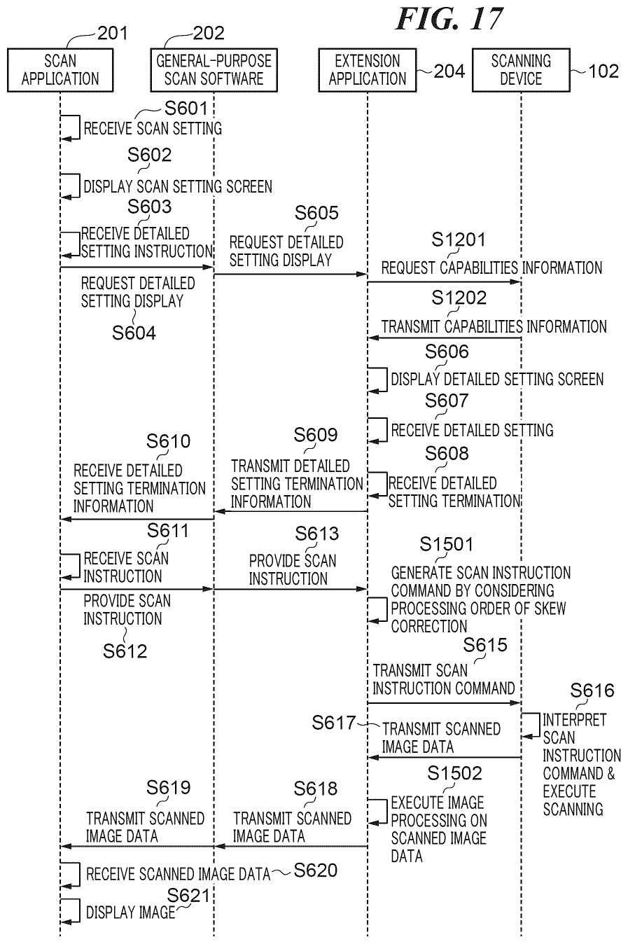

FIG. 17 is a sequence diagram showing a process executed between the scan application 201, the general-purpose scan software 202, the extension application 204, and the scanning device 102, after the scan application receives a scan setting instruction. Different from the sequence diagram shown in FIG. 14, the steps S1203 and S1204 are omitted in the sequence diagram shown in FIG. 17. Further, a step S1501 is executed in place of the step S614, and a step S1502 is executed in place of the step S1205. Referring to FIG. 17, in the step S1501, the extension application 204 generates a scan instruction command. This generation of the scan instruction command is performed based on the capabilities information acquired from the scanning device 102 in the step S1202, and the setting information written in the scan function information 203 in the step S608. Specifically, the skew correction processing is executed by the extension application 204, and a command is not added to the scan instruction with respect to a function having the information 2003 set to “o”. This makes it possible to prevent image processing which is to be executed after execution of the skew correction processing from being executed before execution of the skew correction processing.

In the step S1502, the image data-editing unit 207 of the extension application 204 executes, on image data, processing which is not supported by the scanning device 102 and at the same time is not included in the scan instruction command generated in the step S1501. In the present embodiment, first, the skew correction processing is executed, and thereafter, the blank sheet skip processing is executed.

As described above, in the present embodiment, even when the scanning device 102 does not have the skew correction function, it is made possible not only to execute the skew correction processing, but also to execute the processing by considering the execution order with the other function. This makes it possible to provide a proper processing result, by preventing processing to be executed after execution of the skew correction processing from being executed before execution of the skew correction processing.

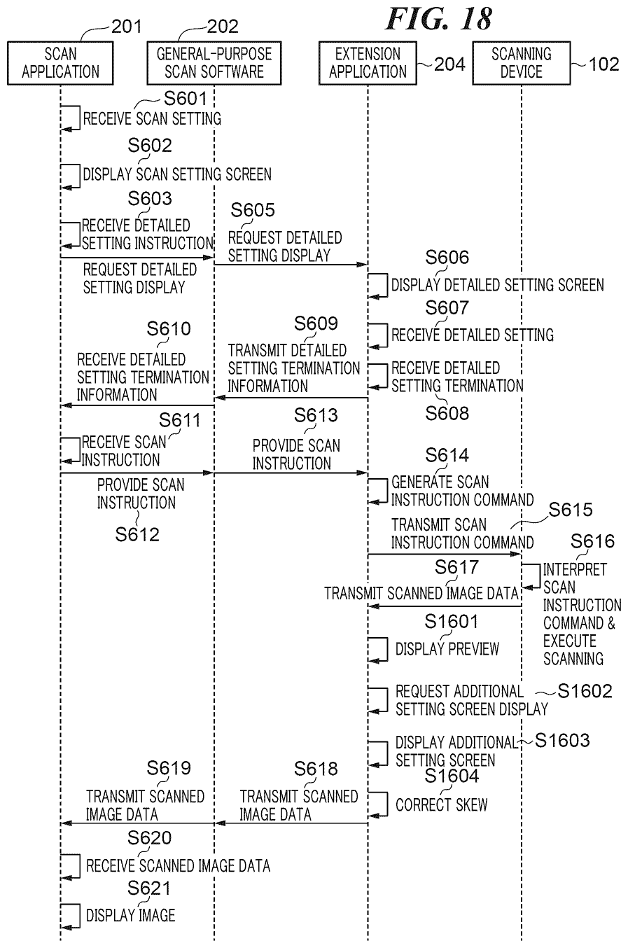

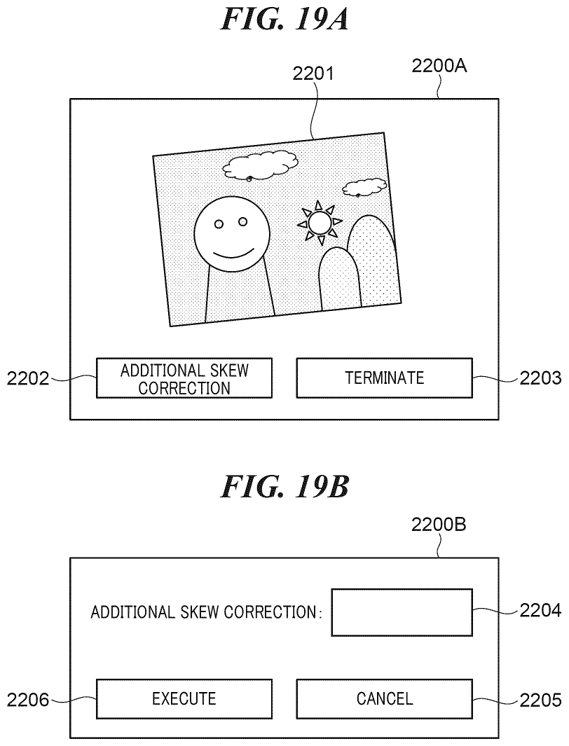

A sixth embodiment will be described below with reference to FIGS. 18, 19A, and 19B, but the description will be given mainly of different points from the above-described embodiments, and description of the same points is omitted. In a case where the skew correction processing is defined as first skew correction processing, execution of only the first skew correction processing can result in an insufficient skew correction, depending on conditions, such as light and dark in an image. For example, in a case of an original on which an image of a background of a dark color is printed and from which an edge is difficult to be detected, execution of only the first skew correction processing can result in insufficient skew correction. In the present embodiment, the description will be given of a configuration that can reduce this problem.

FIG. 18 is a sequence diagram showing a process executed, in the sixth embodiment, between the scan application 201, the general-purpose scan software 202, the extension application 204, and the scanning device 102, after the scan application receives a scan setting instruction. In the sequence diagram shown in FIG. 18, differently from the sequence diagram shown in FIG. 6, steps S1601 to S1604 are sequentially executed between the steps S617 and S618. Referring to FIG. 18, in the step S1601, the extension application 204 receives an image obtained after execution of the skew correction processing, transmitted in the step S617. Then, the extension application 204 displays this preview image on the display section 119.

In the step S1602, the extension application 204 receives an additional setting screen display request.

In the step S1603, the extension application 204 displays an additional setting screen on the display section 119 in response to the additional setting screen display request received in the step S1602. On this additional setting screen, a setting of additional skew correction processing can be made. This additional skew correction processing is hereinafter sometimes referred to as the second skew correction processing.

In the step S1604, the image data-editing unit 207 of the extension application 204 executes the additional skew correction processing on the image data received in the step S1601, based on the setting of the additional skew correction processing, received in the step S1603.

FIGS. 19A and 19B are diagrams each showing an example of a screen displayed on the display section of the scan system. A screen 2200A shown in FIG. 19A is the preview screen displayed in the step S1601. A screen 2200B shown in FIG. 19B is the additional setting screen displayed in the step S1603. This screen 2200B is used for setting the additional skew correction processing. As shown in FIG. 19A, the screen 2200A includes an image 2201, a control 2202, and a control 2203. As described above, in the case of the original on which an image of a background of a dark color is printed and from which an edge is difficult to be detected, execution of only the skew correction processing can result in insufficient skew correction. As a result, skew remains in the image 2201. The control 2202 is a button for shifting the screen to the screen 2200B. When the control 2202 is operated, the screen 2200B is displayed. The control 2203 is a button for terminating the screen 2200A. When the control 2203 is operated, the screen 2200A is terminated, and the step S618 is executed.

As shown in FIG. 19B, the screen 2200B includes controls 2204 to 2206. The control 2204 is an input field (input screen) on which the user can input a desired numerical value for correcting skew by the additional skew correction processing. Note that the user can view the skew of the image 2201 on the screen 2200A and input a numerical value which cancels out an angle of this skew in the control 2204. When the control 2206 is operated in a state in which a numerical value has been input in the control 2204, image data forming the image 2201 is subjected to processing for rotation of the image 2201 by an amount corresponding to the numerical value input in the control 2204 (second skew correction processing). With this, the skew which cannot be sufficiently corrected by execution of the first skew correction processing can be corrected by the second skew correction processing. The control 2205 is a button for canceling the second skew correction processing. As described above, in the present embodiment, if an image on which the first skew correction processing has been executed is still skewed, it is possible to further execute the second skew correction processing for additionally correcting the skew. This makes it possible to obtain the image of which the skew has been eliminated.

According to the present disclosure, in a case where a scanned image is skewed, it is possible to correct the skew of this scanned image.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-135307 filed Aug. 14, 2024, which is hereby incorporated by reference herein in its entirety.

What is claimed is:

1. A non-transitory computer-readable storage medium storing a program supporting a general-purpose program which can be used for image processing apparatuses of a plurality of makers, each having a scan function, the program causing a computer to:
perform extraction of a feature amount from an image obtained by the scan function; and
display a setting reception screen for receiving a setting of skew correction processing for correcting, in a case where the image has a skew, the skew of the image based on the feature amount.

2. The storage medium according to claim 1, wherein the program further causes the computer to instruct the image processing apparatus to execute the skew correction processing according to the setting received on the setting reception screen, and
wherein the image processing apparatus is capable of executing the skew correction processing according to the instruction.

3. The storage medium according to claim 2, wherein, assuming that the skew correction processing mentioned above is defined as first skew correction processing, the program causes the computer to execute, if the image on which the first skew correction processing has been executed still has a skew, second skew correction processing for correcting this skew.

4. The storage medium according to claim 3, wherein the program causes the computer to display an input screen for inputting the skew to be corrected by the second skew correction processing, by a numerical value.

5. The storage medium according to claim 1, wherein the program can switch whether or not to display the setting reception screen according to the image processing apparatus.

6. The storage medium according to claim 5, wherein the program causes the computer to perform acquisition of capabilities information related to capabilities of executing the scan function from the image processing apparatus before displaying the setting reception screen, and
perform determination of whether or not information which enables display of the setting reception screen is included in the capabilities information acquired by the acquisition,
wherein as a result of the determination, in a case where it is determined that the information which enables display of the setting reception screen is included, the setting reception screen is displayed, whereas in a case where it is determined that information which enables display of the setting reception screen is not included, the setting reception screen is not displayed.

7. The storage medium according to claim 1, wherein on the setting reception screen, execution of the skew correction processing and non-execution of the skew correction processing can be selected.

8. The storage medium according to claim 1, wherein the program causes the computer to display a preview image of the image as obtained before the skew correction processing is executed.

9. The storage medium according to claim 1, wherein the program causes the computer to display a preview image of the image on which the skew correction processing has been executed.

10. The storage medium according to claim 1, wherein the extraction extracts an edge of an original from which the image is to be obtained by the scan function, as the feature amount.

11. The storage medium according to claim 1, wherein the program is configured such that execution of processing to be executed after the skew correction processing can be instructed before execution of the skew correction processing.

12. A non-transitory computer-readable storage medium storing a program supporting a general-purpose program which can be used for image processing apparatuses of a plurality of makers, each having a scan function, the program causing a computer to:
perform extraction of a feature amount from an image obtained by the scan function;
perform display of a setting reception screen for receiving a setting of skew correction processing for correcting, in a case where the image has a skew, the skew of the image based on the feature amount; and
perform execution of the skew correction processing according to the setting received on the setting reception screen.

13. The storage medium according to claim 12, wherein the execution includes generating a corrected image on which the skew of the image has been corrected by executing the skew correction processing, and
wherein the transmission includes transmitting the corrected image as a result of the execution.

14. The storage medium according to claim 12, wherein the program can switch whether or not to display the setting reception screen according to the image processing apparatus.

15. The storage medium according to claim 12, wherein the program causes the computer to perform acquisition of capabilities information related to capabilities of executing the scan function from the image processing apparatus before displaying the setting reception screen, and
perform determination of whether or not information which enables display of the setting reception screen is included in the capabilities information acquired by the acquisition,
wherein as a result of the determination, in a case where it is determined that the information which enables display of the setting reception screen is included, the setting reception screen is displayed, whereas in a case where it is determined that information which enables display of the setting reception screen is not included, the setting reception screen is not displayed.

16. The storage medium according to claim 12, wherein on the setting reception screen, execution of the skew correction processing and non-execution of the skew correction processing can be selected.

17. The storage medium according to claim 12, wherein the program causes the computer to display a preview image of the image as obtained before the skew correction processing is executed.

18. The storage medium according to claim 12, wherein the program causes the computer to display a preview image of the image on which the skew correction processing has been executed.

19. The storage medium according to claim 12, wherein the extraction extracts an edge of an original from which the image is to be acquired by the scan function, as the feature amount.

20. A method of performing control to support a general-purpose program which can be used for image processing apparatuses of a plurality of makers, each having a scan function, comprising:
extracting a feature amount from an image obtained by the scan function; and
displaying a setting reception screen for receiving a setting of skew correction processing for correcting, in a case where the image has a skew, the skew of the image based on the feature amount.
